(19) United States
(12) Patent Application Publication
(10) Pub. No.: US 2026/0087987 A1
(43) Pub. Date: Mar. 26, 2026

(54) ELECTRONIC DEVICE

(71) Applicant: Samsung Display Co., Ltd., Yongin-Si (KR)

(72) Inventors: HYUNAE PARK, Yongin-si (KR); Minki YANG, Yongin-si (KR); JAE-SIC LEE, Yongin-si (KR)

(21) Appl. No.: 19/278,158

(22) Filed: Jul. 23, 2025

(30) Foreign Application Priority Data
Sep. 23, 2024 (KR) 10-2024-0128213

(51) Int. Cl. G09G 3/3233

(52) U.S. Cl. CPC G09G 3/3233; G09G 2300/0426; G09G 2300/0819; G09G 2300/0842; G09G 2300/0861; G09G 2310/0286; G09G 2310/06; G09G 2310/08; G09G 2320/0233; G09G 2320/0238; G09G 2320/0257; G09G 2320/041; G09G 2320/0673; G09G 2330/023

(57) ABSTRACT

An electronic device includes a light emitting element, a data line, a pixel circuit, and a plurality of scan lines. The plurality of scan lines include an initializing scan line and a write scan line. The pixel circuit includes a first transistor including a first gate electrode, a second transistor including a second gate electrode receiving the write scan signal and connected to the data line, and a third transistor receiving the initializing scan signal and connected to the first gate electrode. The initializing scan line, the write scan line, and the first gate electrode are disposed on different layers from each other.

### CROSS-REFERENCE TO RELATED APPLICATIONS

This application claims priority under 35 U.S.C. § 119 to Korean Patent Application No. 10-2024-0128213 filed on Sep. 23, 2024, in the Korean Intellectual Property Office, the disclosures of which are incorporated by reference herein in their entireties.

### BACKGROUND

Embodiments of the present disclosure described herein relate to an electronic device having an improved display quality.

In general, an electronic device, such as a smart phone, a digital camera, a laptop computer, a navigation, or a smart television, provides an image to a user. The electronic device generates an image and provides the generated image to the user through a display screen.

The electronic device includes a plurality of pixels to generate an image and a plurality of lines connected to the pixels. The pixels receive driving signals through the lines and operate accordingly.

### SUMMARY

Embodiments of the present disclosure provide an electronic device having an improved display quality.

According to an embodiment, an electronic device includes a light emitting element, a data line providing a data signal, a pixel circuit connected to the light emitting element, and a plurality of scan lines connected to the pixel circuit. The plurality of scan lines may include an initializing scan line extending in a first direction and providing an initializing scan signal, and a write scan line extending in the first direction and providing a write scan signal. The pixel circuit may include a first transistor including a first semiconductor pattern which includes a first electrode and a second electrode and includes a first material, and a first gate electrode, a second transistor including a second gate electrode which receives the write scan signal, and connected between the first electrode and the data line, and a third transistor including a second semiconductor pattern including a second material different from the first material, receiving the initializing scan signal and connected to the first gate electrode. The initializing scan line, the write scan line, and the first gate electrode may be disposed on different layers from each other.

The write scan line may be overlapped with at least a portion of the first gate electrode, when viewed in a plan view.

The electronic device may further include a first initializing voltage line, disposed on a same layer as the first gate electrode, extending in the first direction, and providing a first initializing voltage, may be further included.

The first initializing voltage line may be electrically connected to the second semiconductor pattern.

The first initializing voltage line may be disposed on a different layer different from the write scan line.

The plurality of scan lines may further include a compensating scan line extending in the first direction and providing a compensating scan signal. The pixel circuit may further include a fourth transistor including a fourth gate electrode which receives the compensating scan signal, the second semiconductor pattern, and electrically connected between the second electrode and the first gate electrode.

The compensating scan line may be disposed on a same layer as the initializing scan line, and the compensating scan line and the initializing scan line may be spaced apart from each other in a second direction crossing the first direction.

The compensating scan line may be disposed on a different layer from the write scan line.

The plurality of scan lines may further include a light emitting control line extending in the first direction and providing a light emitting control signal. The pixel circuit may further include a fifth transistor connected to the first electrode receiving the light emitting control signal.

The light emitting control line is disposed on a different layer from the write scan line.

The pixel circuit may further include a connecting pattern disposed on a same layer as the write scan line, and a capacitor electrode overlapped with the first gate electrode, when viewed in a plan view.

The electronic device may further include a first driving voltage line extending in a second direction crossing the first direction and providing a first driving voltage. The connecting pattern may be connected to the first driving voltage line through a contact hole.

The first driving voltage line may be disposed on a same layer as the data line.

The connecting pattern may be overlapped with the capacitor electrode, when viewed in the plan view.

The write scan line may be spaced apart from the connecting pattern in a second direction crossing the first direction, when viewed in the plan view.

The write scan line may be overlapped with at least a portion of the capacitor electrode, when viewed in the plan view.

The second gate electrode may be disposed on a same layer as the first gate electrode, and the second gate electrode may be connected to the write scan line through a contact hole.

According to an embodiment, an electrode device may include a pixel circuit, a data line providing a data signal, a plurality of scan lines connected to the pixel circuit. The plurality of scan lines may include an initializing scan line extending in a first direction and providing an initializing scan signal, and a write scan line extending in the first direction and providing a write scan signal. The pixel circuit may include a first transistor including a first gate electrode, a second transistor including a second gate electrode which receives the write scan signal, and connected between the first transistor and the data line, and a third transistor including a third gate electrode which receives the initializing scan signal, and connected to the first gate electrode, and a capacitor electrode overlapped with the first gate electrode, when viewed in a plan view. The write scan line may be disposed between the initializing scan line and the data line.

The write scan line may be overlapped with at least a portion of the first gate electrode, when viewed in the plan view. The write scan line may be overlapped with at least a portion of the capacitor electrode, when viewed in the plan view

The second gate electrode may be disposed on a same layer as the first gate electrode, and the second gate electrode may be connected to the write scan line through a contact hole.

### BRIEF DESCRIPTION OF THE DRAWINGS

The above and other features of the present disclosure will become apparent with reference to the accompanying drawings together with the following description about embodiments of the present disclosure.

FIG. 1 is a block diagram illustrating an electronic device according to an embodiment of the present disclosure.

FIG. 2 is a perspective view of an electronic device according to an embodiment of the present disclosure.

FIG. 3 is a cross-sectional view of an electronic device according to an embodiment of the present disclosure.

FIG. 4 is a block diagram illustrating an electronic device according to an embodiment of the present disclosure.

FIG. 5 is a circuit diagram illustrating a pixel according to an embodiment of the present disclosure.

FIG. 6 is a waveform describing an operation of a pixel according to an embodiment of the present disclosure.

FIG. 7 is a plan view of a display panel according to an embodiment of the present disclosure

FIG. 8 is a cross-sectional view of a display panel according to an embodiment of the present disclosure.

FIG. 9 is a plan view illustrating a portion of a circuit layer according to an embodiment of the present disclosure.

FIG. 10 is a plan view illustrating a portion of a circuit layer according to an embodiment of the present disclosure.

FIG. 11 is a plan view illustrating a portion of a circuit layer according to an embodiment of the present disclosure.

FIG. 12 is a plan view illustrating a portion of a circuit layer according to an embodiment of the present disclosure.

FIG. 13 is a plan view illustrating a portion of a circuit layer according to an embodiment of the present disclosure.

FIG. 14 is a plan view illustrating a portion of a circuit layer according to an embodiment of the present disclosure.

FIG. 15 is a plan view illustrating a portion of a circuit layer according to an embodiment of the present disclosure.

### DETAILED DESCRIPTION

In the specification, it will be understood that when an element (or region, layer, portion, etc.) is referred to as being “on”, “connected to” or “coupled to” another element, it can be directly on, connected or coupled to the other element, or indirectly on, connected or coupled to the other element with an intervening element therebetween.

The same reference numeral will be assigned to the same component. In addition, in drawings, thicknesses, proportions, and dimensions of components may be exaggerated for effective description of the features of the present disclosure. The term “and/or” includes any and all combinations of one or more of associated components

Although the terms, “first,” “second,” etc., may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The terms of a singular form include the plural forms unless the context clearly indicates otherwise.

In addition, the terms, “under,” “at a lower portion,” “above,” “an upper portion,” are used to describe the relationship between components illustrated in drawings. The terms are relative and will be described with reference to a direction indicated in the drawing.

It will be further understood that the terms, “comprise,” “include,” “have,” or their variations, specify the presence of stated features, numbers, steps, operations, components, parts, or the combination thereof, but do not preclude the presence or addition of one or more other features, numbers, steps, operations, components, components, and/or the combination thereof.

The terms, “part” or “unit,” refer to a software component or a hardware component to perform a specific function. The hardware component may include field-programmable gate array (FPGA), an application-specific integrated circuit (ASIC), or others. The software component may refer to an executable code and/or data used by the executable code in an addressable storage medium. Accordingly, software components may be, for example, object-oriented software components, class components, and task components, and may include processes, functions, properties, procedures, subroutines, program code segments, driver data, firmware, micro-codes, circuits, data, database, data structures, tables, arrangements or variables.

Unless defined otherwise, all terms (including technical terms and scientific terms) used in the specification have the same meaning as commonly understood by one skilled in the art to which the present disclosure pertains. Furthermore, it will be understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to accompanying drawings.

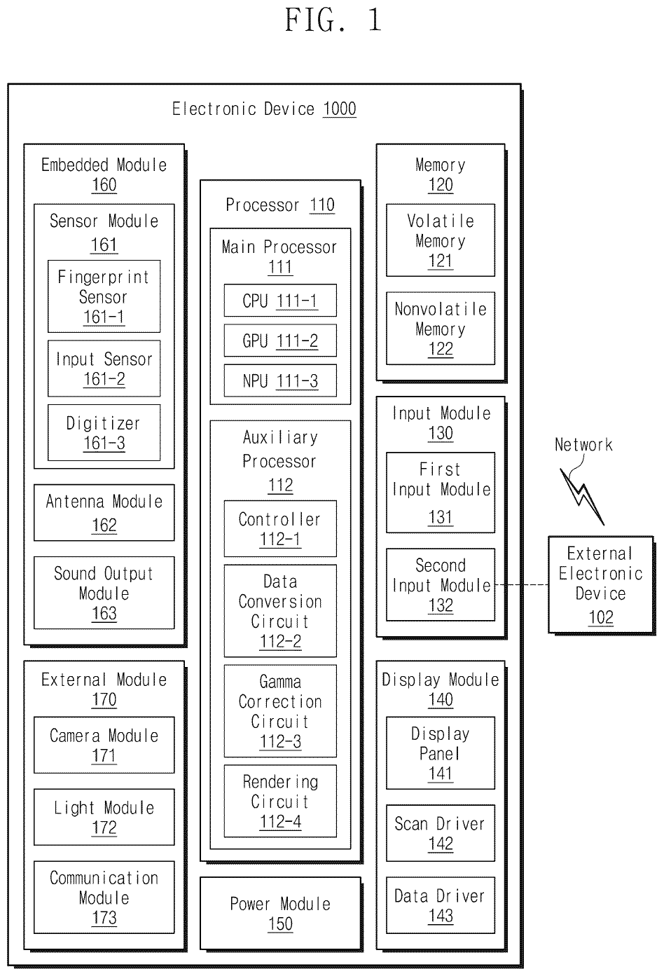

FIG. 1 is a block diagram illustrating an electronic device according to an embodiment of the present disclosure.

Referring to FIG. 1, an electronic device 1000 outputs a variety of information through a display module 140 in an operating system. When a processor 110 executes an application stored in a memory 120, the display module 140 provides a user with application information through a display panel 141.

The processor 110 obtains an external input through an input module 130 or a sensor module 161, and executes an application corresponding to the external input. For example, when a user selects a camera icon displayed on the display panel 141, the processor 110 obtains a user input through an input sensor 161-2 and activates a camera module 171. The processor 110 transmits image data corresponding to a photographed image obtained through the camera module 171 to the display module 140. The display module 140 may display an image corresponding to the photographed image through the display panel 141.

For example, when authentication for personal information is performed in the display module 140, a fingerprint sensor 161-1 obtains input fingerprint information as input data. The processor 110 compares the input data obtained through the fingerprint sensor 161-1 and authentication data stored in the memory 120, and executes an application depending on a comparison result. The display module 140 may display information, which is executed through logic of the application, through the display panel 141.

For example, when a user selects a music streaming icon displayed on the display module 140, the processor 110 obtains the user input through the input sensor 161-2 and activates a music streaming application stored in the memory 120. When a music play command is input to the music streaming application, the processor 110 activates a sound output module 163 and provides the user with sound information corresponding to the music play command.

Hereinabove, the operation of the electronic device 1000 has been described in brief. Hereinafter, components of the electronic device 1000 will be described in detail. Some of the electronic device 1000 to be described later may be integrated with each other and may be provided in the form of a component, or a component of the electronic device 1000 may be separated into at least two components to be provided.

The electronic device 1000 may communicate with an external electronic device 102 over a network (e.g., a short-range wireless communication network or a long-range wireless communication network). According to an embodiment, the electronic device 1000 may include the processor 110, the memory 120, the input module 130, the display module 140, a power module 150, an embedded module 160, and an external module 170. According to an embodiment, the electronic device 1000 may not include at least one of the above components or may further include at least one different component. According to an embodiment, some of the above components (e.g., the sensor module 161, an antenna module 162, or the sound output module 163) may be integrated into any other component (e.g., the display module 140).

The processor 110 may execute software to control at least a component (e.g., a hardware or software component) of the electronic device 1000 connected to the processor 110 and may perform various data processing or operations. According to an embodiment, as at least a part of the data processing or operations, the processor 110 may store a command or data received from a different component (e.g., the input module 130, the sensor module 161, or a communication module 173) in a volatile memory 121, may process the command or data stored in the volatile memory 121, and may store the result data in a non-volatile memory 122.

The processor 110 may include a main processor 111 and an auxiliary processor 112. The main processor 111 may include at least one of a central processing unit (CPU) 111-1, or an application processor (AP). The main processor 111 may further include at least one of a graphic processing unit (GPU) 111-2, a communication processor (CP), or an image signal processor (ISP). The main processor 111 may further include a neural processing unit (NPU) 111-3. The NPU may function as a processor specified for processing an AI model, and the AI model may be created through machine learning. The AI model may include a plurality of artificial neural network (ANN) layers. The ANN may include a deep neural network (DNN), a convolutional neural network (CNN), a recurrent neural network (RNN), a restricted boltzman machine (RBM), a deep belief network (DBN), a bidirectional recurrent deep neural network (BRDNN), a deep Q-networks or the combination of at least two of the above networks, but the disclosure is not limited thereto. The AI model may include a software structure in addition to a hardware structure. At least two of the above processing units and processors may be integrally implemented as a component (e.g., a single chip), or each of the above processing units and processors may be implemented as an independent component (e.g., a plurality of chips).

The auxiliary processor 112 may include a controller 112-1. The controller 112-1 may include an interface conversion circuit and a timing control circuit. The controller 112-1 receives an image signal from the main processor 111, and outputs image data after converting a data format of the image signal to be suitable for the specification of an interface of the display module 140. The controller 112-1 may output various kinds of control signals necessary to drive the display module 140.

The auxiliary processor 112 may further include a data conversion circuit 112-2, a gamma correction circuit 112-3, and a rendering circuit 112-4. The data conversion circuit 112-2 may receive image data from the controller 112-1, may compensate for the image data in order for an image to be displayed with a desired brightness depending on a characteristic of the electronic device 1000 or user settings, or may convert the image data to reduce power consumption or to compensate for afterimages. The gamma correction circuit 112-3 may convert the image data or the gamma reference voltage such that an image displayed on the electronic device 1000 has a desired gamma characteristic. The rendering circuit 112-4 may receive the image data from the controller 112-1, and may render the image data in consideration of a pixel arrangement of the display panel 141 included in the electronic device 1000. At least one of the data conversion circuit 112-2, the gamma correction circuit 112-3, and the rendering circuit 112-4 may be integrated into any other component (e.g., the main processor 111 or the controller 112-1). At least one of the data conversion circuit 112-2, the gamma correction circuit 112-3, and the rendering circuit 112-4 may be integrated into a data driver 143 to be described later.

The memory 120 may store various data, such as input or output data related to corresponding commands, used by at least a component (e.g., the processor 110 or the sensor module 161) of the electronic device 1000. The memory 120 may include at least one of the volatile memory 121 and the nonvolatile memory 122.

The input module 130 may receive a command or data to be used by a component (e.g., the processor 110, the sensor module 161, or the sound output module 163) of the electronic device 1000 from the outside of the electronic device 1000 (e.g., the user or the external electronic device 102).

The input module 130 may include a first input module 131 to receive a command or data from the user, and a second input module 132 to receive a command or data from the external electronic device 102. The first input module 131 may include a microphone, a mouse, a keyboard, a key (e.g., a button), or a pen (e.g., a passive pen or an active pen). The second input module 132 may support a specified protocol capable of connecting to the external electronic device 102 in a wired or wireless manner. According to an embodiment, the second input module 132 may include a high definition multimedia interface (HDMI), a universal serial bus (USB) interface, an SD card interface, or an audio interface. The second input module 132 may include a connector that can be physically connected to the external electronic device 102, for example, an HDMI connector, a USB connector, an SD card connector, or an audio connector (e.g., a headphone connector).

The display module 140 visually provides information to the user. The display module 140 may include the display panel 141, a scan driver 142, and a data driver 143. The display module 140 may further include a window, a chassis, and a bracket for protecting the display panel 141.

The display panel 141 may include a liquid crystal display panel, an organic light emitting display panel, or an inorganic light emitting display panel, and the type of the display panel 141 is not particularly limited. The display panel 141 may be a rigid type or may be a flexible type capable of being rolled or folded. The display module 140 may further include a supporter supporting the display panel 141, a bracket, or a heat dissipation member.

The scan driver 142 may be mounted on the display panel 141 as a driving chip. In addition, the scan driver 142 may be integrated into the display panel 141. For example, the scan driver 142 may include an ASG (Amorphous Silicon) TFT gate driver circuit, an LTPS (Low Temperature Polycrystalline Silicon) TFT gate driver circuit, or an OSG (Oxide Semiconductor) TFT gate driver circuit built in the display panel 141. The scan driver 142 receives a control signal from the controller 112-1, and output scan signals to the display panel 141 in response to a control signal.

The display panel 141 may further include a light emitting driver. The light emitting driver outputs a light emitting control signal to the display panel 141, in response to a control signal received from the controller 112-1. The light emitting driver may be formed independently from the scan driver 142 or may be integrated into the scan driver 142.

The data driver 143 receives a data control signal from the controller 112-1. After converting image data into an analog voltage (e.g., a data voltage) in response to the control signal, the data driver 143 outputs data voltages to the display panel 141.

The data driver 143 may be a part of a different component (e.g., the controller 112-1), or may be formed in a separate component. The functions of the interface conversion circuit and the timing control circuit of the controller 112-1 described above may be integrated into the data driver 143.

The display module 140 may further include a voltage generation circuit. The voltage generation circuit may output various kinds of voltages necessary to drive the display panel 141.

The power module 150 supplies a power to the components of the electronic device 1000. The power module 150 may include a battery that charges a power supply voltage. The battery may include a primary cell not rechargeable, a secondary cell rechargeable, or a fuel cell. The power module 150 may include a power management integrated circuit (PMIC). The PMIC supplies a power optimized for each of the modules described above and modules to be described later. The power module 150 may include a wireless power transmission/reception member electrically connected to the battery. The wireless power transmission/reception member may include a plurality of antenna radiators having the form of a coil.

The electronic device 1000 may further include the embedded module 160 and the external module 170. The embedded module 160 may include the sensor module 161, an antenna module 162, and a sound output module 163. The external module 170 may include the camera module 171, a light module 172, and the communication module 173.

The sensor module 161 may sense an input from a user or a pen of the first input module 131, and generate an electrical signal or a data value corresponding to the input. The sensor module 161 may include at least one of the fingerprint sensor 161-1, the input sensor 161-2, and a digitizer 161-3.

The fingerprint sensor 161-1 may generate a data value corresponding to the user's fingerprint. The fingerprint sensor 161-1 may include one of an optical fingerprint sensor or a capacitive fingerprint sensor.

The input sensor 161-2 may generate a data value corresponding to coordinate information of the input by the user or the input by the pen. The input sensor 161-2 generates a capacitance change due to the input as a data value. The input sensor 161-2 may sense the input by the passive pen or may exchange data with the active pen.

The input sensor 161-2 may measure a biometric signal such as blood pressure, moisture, or body fat. For example, when the user touches his/her body part to a sensor layer or a sensing panel and does not move for a specific time period, the input sensor 161-2 may sense the biometric signal based on a change in an electric field caused by the body part of the user and may output the information desired by the user to the display module 140.

The digitizer 161-3 may generate a data value corresponding to the coordinate information of the input by the pen. The digitizer 161-3 generates the amount of electromagnetic change by the input as a data value. The digitizer 161-3 may sense the input by the passive pen, or may exchange data with the active pen.

At least one of the fingerprint sensor 161-1, the input sensor 161-2, and the digitizer 161-3 may be implemented as a sensor layer formed on the display panel 141 through a subsequent process. The fingerprint sensor 161-1, the input sensor 161-2, and the digitizer 161-3 may be disposed above/on the display panel 141, and any one of the fingerprint sensor 161-1, the input sensor 161-2, and the digitizer 161-3, for example, the digitizer 161-3, may be disposed below/under the display panel 141.

At least two of the fingerprint sensor 161-1, the input sensor 161-2, and the digitizer 161-3 may be integrally formed into one sensing panel through the same process. When they are integrally formed into one sensing panel, the sensing panel may be disposed between the display panel 141 and the window disposed above/on the display panel 141. However, the present disclosure is not limited thereto. For example, the sensing panel may be disposed on the window, and the position of the sensing panel is not specifically limited.

At least one of the fingerprint sensor 161-1, the input sensor 161-2, and the digitizer 161-3 may be embedded in the display panel 141. In other words, at least one of the fingerprint sensor 161-1, the input sensor 161-2, and the digitizer 161-3 may be simultaneously formed through a process of forming elements (e.g., a light emitting element and transistors) included in the display panel 141.

In addition, the sensor module 161 may generate an electrical signal or a data value corresponding to an internal state or an external state of the electronic device 1000. The sensor module 161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 162 may include at least one antenna to transmit a signal or power to the outside or to receive the signal or power from the outside. According to an embodiment, through an antenna suitable for a communication method, the communication module 173 may transmit a signal to an external electronic device or may receive a signal from the external electronic device. An antenna pattern of the antenna module 162 may be integrated into a component (e.g., the display panel 141) of the display module 140 or the input sensor 161-2.

The sound output module 163, which is a device to output the sound signal out of the electronic device 1000, may include a speaker used for a general purpose, such as multimedia playback or voice recording playback, and a receiver dedicated to receiving a telecommunication (e.g., a phone call). According to an embodiment, the receiver may be formed integrally into the speaker or separately from the speaker. A sound output pattern of the sound output module 163 may be integrated into the display module 140.

The camera module 171 may capture a still image and a moving picture. According to an embodiment, the camera module 171 may include at least a lens, an image sensor, or an image signal processor. The camera module 171 may further include an infrared camera capable of measuring the presence or absence of the user, the position of the user, and the direction of gaze of the user.

The light module 172 may provide light. The light module 172 may include a light emitting diode or a xenon lamp. The light module 172 may operate in association with the camera module 171 or independently from the camera module 171.

The communication module 173 may establish a wired or wireless communication channel between the electronic device 1000 and the external device 102 and support communication through the established communication channel. The communication module 173 may include any one of a wireless communication module, such as a cellular communication module, a short-range wireless communication module, or a global navigation satellite system (GNSS) communication module, and a wired communication module, such as a local region network (LAN) communication module or a power line communication module or may include all thereof. The communication module 173 may communicate with the external electronic device 102 over a short-range communication network such as Bluetooth, Wi-Fi direct, or infrared data association (IrDA), or a long-range communication network such as a cellular network, the Internet, or a computer network (e.g., a LAN or WAN). The above-described various types of communication modules 173 may be implemented as a single chip or separate individual chips.

The input module 130, the sensor module 161, and the camera module 171 may be associated with the processor 110 while controlling the operation of the display module 140.

The processor 110 outputs commands or data to the display module 140, the sound output module 163, the camera module 171, or the light module 172 based on the input data received from the input module 130. For example, the processor 110 may generate the image data corresponding to the input data received from the mouse or the active pen and may output the image data to the display module 140. The processor 110 may generate command data corresponding to the input data and may outputs the command data to the camera module 171 or the light module 172. When input data are not received from the input module 130 for a specific time period, the processor 110 may switch an operating mode of the electronic device 1000 to a low-power mode or a sleep mode such that the power consumption of the electronic device 1000 is reduced.

The processor 110 outputs commands or data to the display module 140, the sound output module 163, the camera module 171, or the light module 172 based on the sensing data received from the sensor module 161. For example, the processor 110 compares data obtained through the fingerprint sensor 161-1 with authentication data stored in the memory 120, and executes an application depending on a comparison result. The processor 110 may execute a command based on the sensing data sensed by the input sensor 161-2 or the digitizer 161-3, or may output image data corresponding to the sensing data to the display module 140. When the sensor module 161 includes a temperature sensor, the processor 110 may receive temperature data associated with the measured temperature from the sensor module 161 and may further perform brightness correction on the image data, based on the temperature data.

The processor 110 may receive measurement data about the presence or absence of the user, the location of the user, and the direction of gaze of the user from the camera module 171. The processor 110 may further perform the brightness correction on the image data based on the measurement data. For example, the processor 110 that determines the presence or absence of the user through the input from the camera module 171 may display, to the display module 140, brightness corrected image data through the data conversion circuit 112-2 or the gamma correction circuit 112-3.

Some of the above components may be connected with each other through a communication scheme between peripheral devices, for example, a bus, a general purpose input/output (GPIO), a serial peripheral interface (SPI), a mobile industry processor interface (MIPI), or an ultra-path interconnect (UPI) link, and may exchange signals (e.g., commands or data) with each other. The processor 110 may communicate with the display module 140 through a specific interface. For example, one of the communication methods described above may be used, and the present disclosure is not limited thereto.

The electronic device 1000 according to an embodiment of the present disclosure may be implemented as various types of devices. The electronic device 1000 may include, for example, at least one of a portable communication device (e.g., a smartphone), a computer device, a portable multimedia device, a portable medical device, a camera, a wearable device, and home appliances. The electronic device 1000 according to an embodiment of the present disclosure is not limited to the above devices.

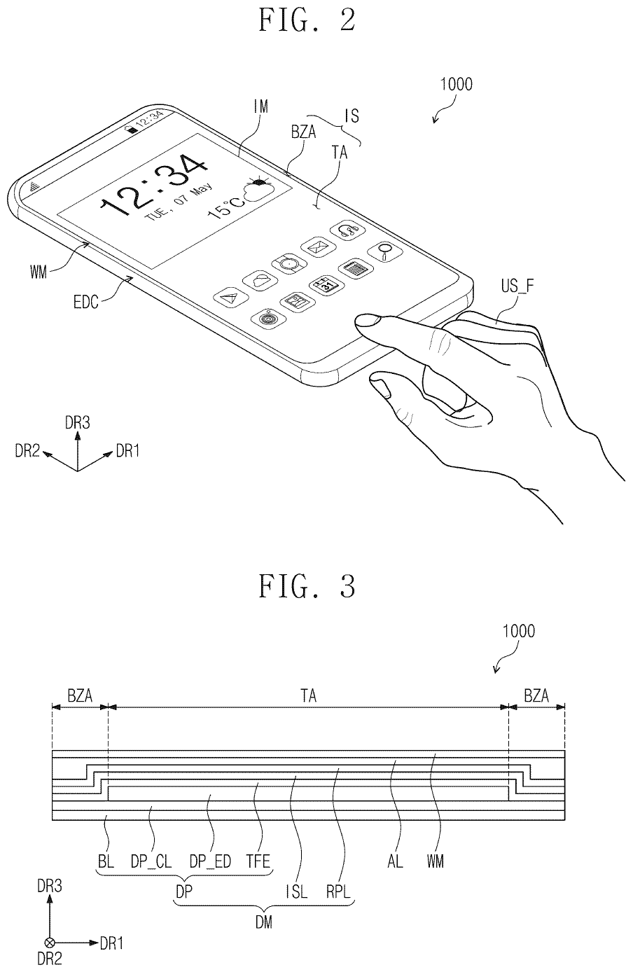

FIG. 2 is a perspective view of an electronic device according to an embodiment of the present disclosure, and FIG. 3 is a block diagram of an electronic device according to an embodiment of the present disclosure.

Referring to FIGS. 2 and 3, an electronic device 1000 may be formed in a rectangle shape having a shorter side parallel to a first direction DR1 and a longer side parallel to a second direction DR2 crossing the first direction DR1. However, an embodiment of the present disclosure is not limited thereto, and the electronic device 1000 may have various shapes such as a circle or a polygon.

The electronic device 1000 may be a device activated in response to an electrical signal. The electronic device 1000 may include various embodiments. For example, the electronic device 1000 may be implemented as a smart watch, a tablet PC, a laptop computer, a computer, or a smart television.

Hereinafter, a direction substantially normal to a plane defined by the first direction DR1 and the second direction DR2 is defined as a third direction DR3. In the specification, the meaning of “when viewed in a plan view” may refer to “when viewed in the third direction DR3”.

A top surface of the electronic device 1000 may be defined as a display surface IS and may be parallel to the plane defined by the first direction DR1 and the second direction DR2. Images IM generated by the electronic device 1000 may be provided to a user through the display surface IS.

The display surface IS may be divided into a transparent region TA and a bezel region BZA. The transparent region TA may be a region in which the images IM are displayed. The user visually perceives the images IM through the transparent region TA. According to an embodiment, the transparent region TA is illustrated in the shape of a quadrangle having vertexes rounded. However, this is provided only for the illustrative purpose. However, an embodiment of the present disclosure is not limited thereto, and the transparent region TA may be implemented in various shapes.

The bezel region BZA is adjacent to the transparent region TA. The bezel region BZA may have a specific color. The bezel region BZA may surround the transparent region TA. Accordingly, the shape of the transparent region TA may be defined substantially by the bezel region BZA. However, this is provided only for the illustrative purpose. For example, the bezel region BZA may be only disposed adjacent to one side of the transparent region TA or may be omitted.

The electronic device 1000 may sense an external input applied from the outside. The external input may include various inputs applied from an outside of the electronic device 1000. For example, as well as a contact by a part, such as a user hand US_F, of a user body or a contact made by an additional device (for example, an active pen or a digitizer), the external input may include an external input (for example, a hovering input) which is applied when the user's hand approaches the electronic device ED or becomes close to the electronic device ED within a specific distance. In addition, the external input may have various types such as force, pressure, a temperature, and a light.

The electronic device 1000 may include a window WM, an electronic module DM, and a housing EDC. According to an embodiment, the window WM and the housing EDC are coupled to form the appearance of the electronic device 1000.

A front surface of the window WM defines the display surface IS of the electronic device 1000. The window WM may include an optically transparent insulating material. For example, the window WM may include glass or plastic. The window WM may include a multi-layer structure or a single-layer structure. For example, the window WM may include a plurality of plastic films bonded by an adhesive or may have a glass substrate and a plastic film bonded by an adhesive.

The electronic module DM includes a display panel DP and an input sensor ISL. The display panel DP may display an image in response to an electrical signal. The display panel DP may be a component substantially the same as the display panel 141 illustrated in FIG. 1. The input sensor ISL may sense an external input that is applied from the outside. The external input may be provided in various forms. The input sensor ISL may be a component substantially the same as the input sensor 161-2 described with reference to FIG. 1.

The display panel DP according to an embodiment of the present disclosure may be an emissive-type display panel and the present disclosure is not particularly limited thereto. For example, the display panel DP may be an organic light emitting display panel, an inorganic light emitting display panel, or a quantum dot light emitting display panel. A light emitting layer of the organic light emitting display panel may include an organic light emitting material, and a light emitting layer of the inorganic light emitting display panel may include an inorganic light emitting material. A light emitting layer of the quantum dot light emitting display panel may include a quantum dot, or a quantum rod. Hereinafter, the display panel DP will be described as an organic light emitting display panel.

The display panel DP includes a base layer BL, a circuit layer DP_CL, an element layer DP-ED, and an encapsulating layer TFE. The display panel DP according to the present disclosure may be a flexible display panel. However, the present disclosure is not limited thereto. For example, the display panel DP may be a foldable display panel, which is folded along a folding axis, or a rigid display panel.

The base layer BL may include a synthetic resin layer. The synthetic resin layer may include a polyimide-based resin layer. However, the material of the base layer BL is not limited thereto. For example, the base layer BL may include a glass substrate, a metal substrate, or an organic/inorganic composite material substrate.

The circuit layer DP_CL may be disposed on the base layer BL. The circuit layer DP_CL may be interposed between the base layer BL and an element layer DP_ED. The circuit layer DP_CL may include at least one insulating layer and a circuit element. Hereinafter, the insulating layer included in the circuit layer DP_CL may be referred to as an intermediate insulating layer. The intermediate insulating layer includes at least one intermediate inorganic film and at least one intermediate organic film. The circuit element may include a pixel driving circuit included in each of the plurality of pixels to display an image, and a sensor driving circuit included in each of a plurality of sensors to recognize external information. The external information may be biometric information. According to an embodiment of the present disclosure, the sensor may include a fingerprint sensor, a proximity sensor, an iris recognizing sensor, a blood pressure measuring sensor, or an illuminance sensor. In addition, the sensor may be an optical sensor to optically recognize biometrics information. The circuit layer DP_CL may further include signal lines connected to a pixel driving circuit and/or a sensor driving circuit.

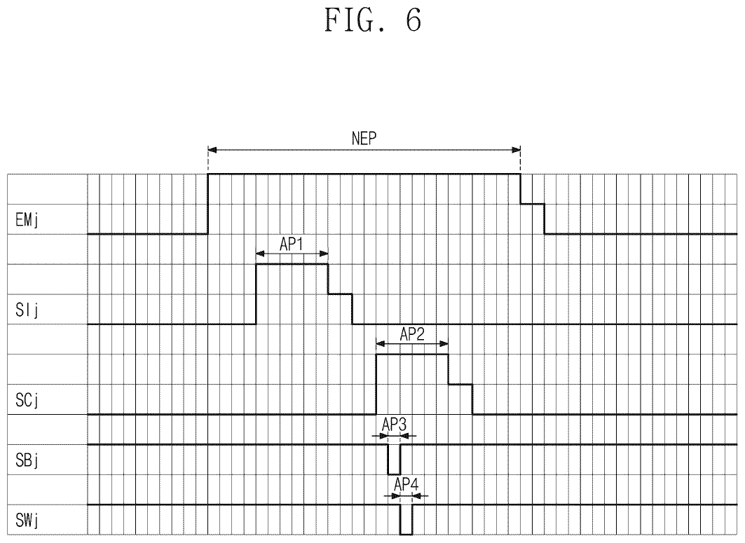

The element layer DP_ED may include a light emitting element included in each pixel, and a light receiving element included in each of the sensors. According to an embodiment of the present disclosure, the light receiving element may be a photo-diode. The light receiving element may be a sensor to sense light reflected from the fingerprint of the user or a sensor reacting to light. The circuit layer DP_CL and the element layer DP_ED will be described in detail later with reference to FIG. 6.

The encapsulating layer TFE encapsulates the element layer DP_ED. The encapsulating layer TFE may include at least one organic layer and at least one inorganic layer. The inorganic film may include an inorganic material to protect the element layer DP_ED from moisture/oxygen. The inorganic layer may include a silicon nitride layer, a silicon oxy nitride layer, a silicon oxide layer, a titanium oxide layer, or an aluminum oxide layer. The organic layer may include an organic material and may protect the element layer DP_ED from foreign substances such as dust particles.

The input sensor ISL may be formed on the display panel DP. The input sensor ISL may be directly disposed on the encapsulating layer TFE. According to an embodiment of the present disclosure, the input sensor ISL may be formed on the display panel DP through the same process as for the display panel DP. In other words, when the input sensor ISL is directly disposed on the display panel DP, an adhesive film is not disposed between the input sensor ISL and the encapsulating layer TFE. However, the present disclosure is not limited thereto. For example, an adhesive film may be interposed between the input sensor ISL and the display panel DP. In this case, the input sensor ISL may not be manufactured through the same process as for the display panel DP. For example, after the input sensor ISL is manufactured through a separate process from the process for the display panel DP, the input sensor ISL may be fixed to a top surface of the display panel DP using the adhesive film.

The input sensor ISL may sense an external input (e.g., a touch by the user), may change the sensed input into a specific input signal, and may provide the input signal to the display panel DP. The input sensor ISL may include a plurality of sensing electrodes to sense an external input. The sensing electrodes may sense the external input in a capacitive type. The display panel DP may receive an input signal applied from the input sensor ISL and may generate an image corresponding to the input signal.

The electronic module DM may further include an anti-reflective layer RPL. The anti-reflective layer RPL may reduce the reflectance of the external light incident to the display panel DP from the outside of the electronic device 1000. The external light may not be perceived by the user due to the anti-reflective layer RPL. According to an embodiment of the present disclosure, the anti-reflective layer RPL may be disposed on the input sensor ISL. However, the present disclosure is not limited thereto. For example, the anti-reflective layer RPL may be interposed between the display panel DP and the input sensor ISL. The anti-reflective layer RPL may include a plurality of color filters disposed in spaces corresponding to the pixels, respectively. The color filters may filter the external light to match the colors of the pixels. In this case, the external light may not be viewed by the user. However, the present disclosure is not limited thereto. For example, the anti-reflective layer RPL may include a phase retarder and/or a polarizer, to reduce the reflectance of the external light.

The electronic device 1000 according to an embodiment of the present disclosure may further include an adhesive layer AL. The window WM may be attached to the anti-reflective layer RPL through an adhesive layer AL. The adhesive layer AL may include an optical clear adhesive, an optically clear adhesive resin, or a pressure sensitive adhesive (PSA).

The housing EDC is coupled to the window WM. The housing EDC is coupled to the window WM to provide a specific inner space. The electronic module DM may be accommodated in the inner space. The housing EDC may include a material having higher rigidity. For example, the housing EDC may include glass, plastic, or metal, or may include a plurality of frames and/or a plurality of plates including a combination of glass, plastic, or metal. The housing EDC may stably protect components of the electronic device 1000, which are placed in the inner space, from an external impact. Although not illustrated, a battery module which supplies a power necessary for the overall operation of the electronic device 1000 may be interposed between the electronic module DM and the housing EDC.

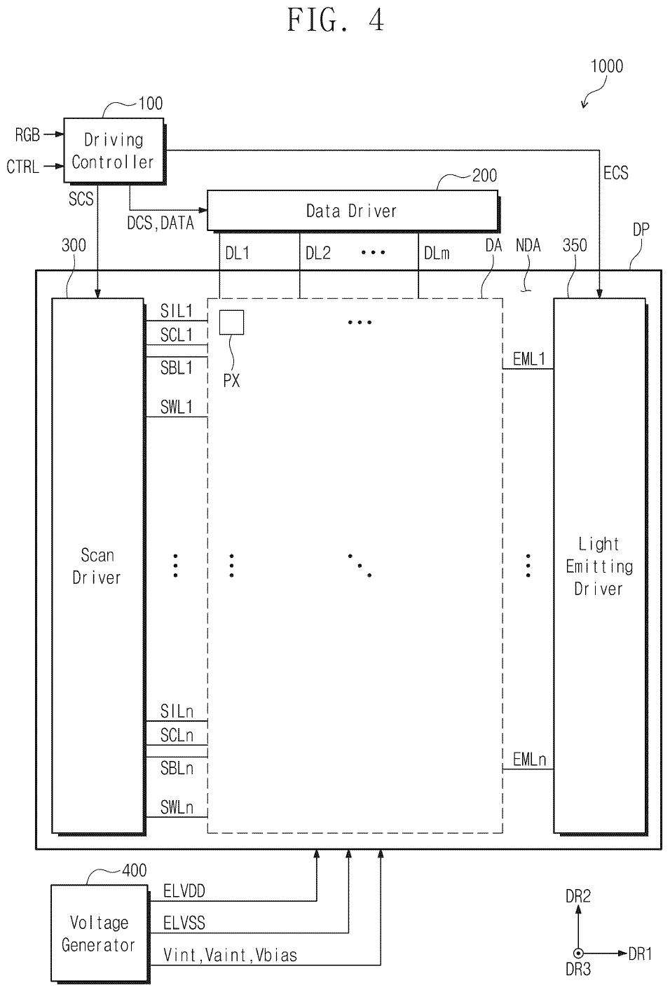

FIG. 4 is a block diagram illustrating an electronic device according to an embodiment of the present disclosure.

Referring to FIG. 4, the electronic device 1000 includes the display panel DP, a panel driver, and a driving controller 100. According to an embodiment of the present disclosure, the panel driver includes a data driver 200, a scan driver 300, a light emitting driver 350, and a voltage generator 400. The data driver 200 may be a component substantially the same as the data driver 143 illustrated in FIG. 1. The scan driver 300 may be a component substantially the same as the scan driver 142 described with reference to FIG. 1.

The driving controller 100 receives an image signal RGB and a control signal CTRL. The driving controller 100 generates image data DATA by converting a data format of the image signal RGB to match the interface specification of the data driver 200. The driving controller 100 outputs a first control signal SCS, a second control signal ECS, and a third control signal DCS.

The data driver 200 receives the third control signal DCS and the image data DATA from the driving controller 100. The data driver 200 converts the image data DATA into data signals, and outputs the data signals to the plurality of data lines DL1 to DLm. The data signals refer to analog voltages corresponding to grayscale values of the image data DATA.

The scan driver 300 receives the first control signal SCS from the driving controller 100. The scan driver 300 may output scan signals to scan lines in response to the first control signal SCS.

The voltage generator 400 generates voltages necessary for an operation of the display panel DP. According to an embodiment, the voltage generator 400 may generate a first driving voltage ELVDD, a second driving voltage ELVSS, a first initializing voltage Vint1, a second initializing voltage Vint2, and a bias voltage Vbias.

The display panel DP may include a display region DA corresponding to the transparent region TA (see FIG. 2) and a non-display region NDA corresponding to the bezel region BZA (see FIG. 2).

The display panel DP may include a plurality of pixels PX disposed in the display region DA. The display panel DP further includes initializing scan lines SIL1 to SILn, compensating scan lines SCL1 to SCLn, write scan lines SWL1 to SWLn, black scan lines SBL1 to SBLn, light emitting control lines EML1 to EMLn, and data lines DL1 to DLm. The initializing scan lines SIL1 to SILn, the compensating scan lines SCL1 to SCLn, the write scan lines SWL1 to SWn, the black scan lines SBL1 to SBLn, and the light emitting control lines EML1 to EMLn extend in the first direction DR1. The initializing scan lines SIL1 to SILn, the compensating scan lines SCL1 to SCLn, the write scan lines SWL1 to SWLn, the black scan lines SBL1 to SBLn, and the light emitting control lines EML1 to EMLn are arranged to be spaced from each other in the second direction DR2. The data lines DL1 to DLm extend in the second direction DR2, and are arranged to be spaced from each other in the first direction DR1. In this case, “m” and “n” are natural numbers equal to or greater than ‘1’.

The plurality of pixels PX are electrically connected to the initializing scan lines SIL1 to SILn, the compensating scan lines SCL1 to SCLn, the write scan lines SWL1 to SWLn, the black scan lines SBL1 to SBLn, the light emitting control lines EML1 to EMLn, and the data lines DL1 to DLm. For example, each of the plurality of pixels PX may be electrically connected to four scan lines. However, the number of scan lines connected to each pixel PX is not limited thereto and may be changed.

The scan driver 300 may be disposed in the non-display region NDA of the display panel DP. The scan driver 300 receives the first control signal SCS from the driving controller 100. In response to the first control signal SCS, the scan driver 300 outputs initializing scan signals to the initializing scan lines SIL1 to SILn and may output compensating scan signals to the compensating scan lines SCL1 to SCLn. In addition, in response to the first control signal SCS, the scan driver 300 may output write scan signals to the write scan lines SWL1 to SWLn and may output black scan signals to the black scan lines SBL1 to SBLn. The scan driver 300 may include a first scan driver and a second scan driver. The first scan driver may output the initializing scan signals and the compensating scan signals, and the second scan driver may output the write scan signals and the black scan signals.

The light emitting driver 350 may be disposed in the non-display region NDA of the display panel DP. The light emitting driver 350 receives the second control signal ECS from the driving controller 100. The light emitting driver 350 may output light emitting control signals to the light emitting control lines EML1 to EMLn in response to the second control signal ECS. The scan driver 300 may be connected to the light emitting control lines EML1 to EMLn. In this case, the light emitting driver 350 may be omitted, and the scan driver 300 may output the light emitting control signals to the light emitting control lines EML1 to EMLn.

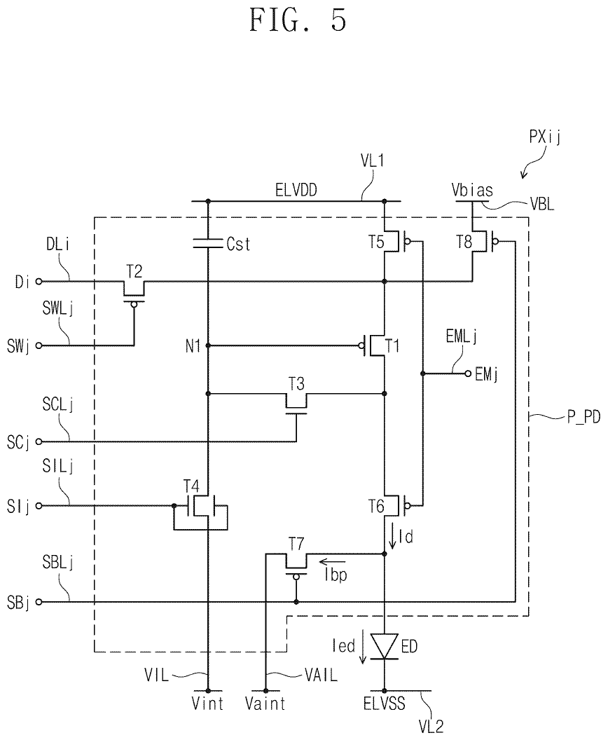

FIG. 5 is a circuit diagram illustrating a pixel according to an embodiment of the present disclosure.

FIG. 5 illustrates an equivalent circuit diagram of one pixel PXij among a plurality of pixels PX illustrated in FIG. 4. Since each of the plurality of pixels PX has the same pixel structure, the circuit structure of the pixel PXij will be representatively described, and the details of remaining pixels will be omitted.

Referring to FIGS. 4 and 5, the pixel PXij may be connected to an i-th data line DLi of the data lines DL1 to DLm, a j-th initializing scan line SILj of the initializing scan lines SIL1 to SILn, a j-th compensating scan line SCLj of the compensating scan lines SCL1 to SCLn, a j-th write scan line SWLj of the write scan lines SWL1 to SWLn, a j-th black scan line SBLj of black scan lines SBL1 to SBLn, and a j-th light emitting control line EMLj of the light emitting control lines EML1 to EMLn.

The pixel PXij includes a light emitting element ED and a pixel driving circuit P_PD. The light emitting element ED may be a light-emitting diode. As an example of the present disclosure, the light emitting element ED may be an organic light emitting diode including an organic light emitting layer.

The pixel driving circuit P_PD includes first to eighth transistors T1, T2, T3, T4, T5, T6, T7, and T8, and one capacitor Cst. At least one of the first to eighth transistors T1 to T8 may be a transistor having a low-temperature polycrystalline silicon (LTPS) semiconductor layer. Some of the first to eighth transistors T1 to T8 may be P-type transistors, and remaining transistors of the first to eighth transistors T1 to T8 may be N-type transistors. At least one of the first to eighth transistors T1 to T8 may be a transistor having an oxide semiconductor layer.

The first, second, fifth to eighth transistors T1, T2, and T5 to T8 may include a semiconductor pattern including a first material, and the third and fourth transistors T3 and T4 may include a semiconductor pattern including a second material different from the first material. For example, the third and fourth transistors T3 and T4 may be oxide semiconductor transistors, and the first, second, and fifth to eighth transistors T1, T2, and T5 to T8 may be LTPS transistors. The third and fourth transistors T3 and T4 may be NMOS transistors, and the first, second, and fifth to eighth transistors T1, T2, and T5 to T8 may be PMOS transistors.

A configuration of the pixel driving circuit P_PD according to the present disclosure is not limited thereto. The pixel driving circuit P_PD illustrated in FIG. 5 is provided only for the illustrative purpose, and the configuration of the pixel driving circuit P_PD may be modified and implemented. For example, all of the first, second, and fifth to eighth transistors T1, T2, and T5 to T8 may be P-type transistors or N-type transistors.

The j-th initializing scan line SILj, the j-th compensating scan line SCLj, the j-th write scan line SWLj, the j-th black scan line SBLj, and the j-th light emitting control line EMLj may transmit the j-th initializing scan signal SIj, the j-th compensating scan signal SCj, the j-th write scan signal SWj, the j-th black scan signal SBj, and the j-th light emitting control signal EMj to the pixel PXij, respectively. The i-th data line DLi transmits the i-th data signal Di to the pixel PXij. The i-th data signal Di may have a voltage level corresponding to the image signal RGB (see FIG. 3) input to the display device DD (see FIG. 3).

According to an embodiment of the present disclosure, the pixel PXij may be connected to the first and second driving voltage lines VL1 and VL2, first and second initializing voltage lines VIL and VAIL, and the bias voltage line VBL. The first driving voltage line VL1 may transmit the first driving voltage ELVDD to the pixel PXij, and the second driving voltage line VL2 may transmit the second driving voltage ELVSS to the pixel PXij. In addition, the first initializing voltage line VIL may transmit the first initializing voltage Vint to the pixel PXij, and the second initializing voltage line VAIL may transmit the second initializing voltage Vaint to the pixel PXij. The bias voltage line VBL may transmit the bias voltage Vbias to the pixel PXij.

The first transistor T1 is connected between the first driving voltage line VL1 receiving the first driving voltage ELVDD and the light emitting element ED. The first transistor T1 includes a first electrode connected to the first driving voltage line VL1 through the fifth transistor T5, a second electrode connected to an anode electrode of the light emitting element ED through the sixth transistor T6, and a third electrode (for example, a gate electrode) connected to the first terminal (for example, a first node N1) of the capacitor Cst. The first transistor T1 may receive the i-th data signal Di through the i-th data line DLi depending on a switching operation of the second transistor T2 and may supply a driving current Id to the light emitting element ED.

The second transistor T2 is connected between the i-th data line DLi and the first electrode of the first transistor T1. The second transistor T2 includes a first electrode connected to the i-th data line DLi, a second electrode connected to the first electrode of the first transistor T1, and a third electrode (e.g., a gate electrode) connected to the j-th write scan line SWLj. The second transistor T2 may be turned on in response to the write scan signal SWj received through the j-th write scan line SWLj to transmit the i-th data signal Di received from the i-th data line DLi to the first electrode of the first transistor T1.

The third transistor T3 is connected between the second electrode of the first transistor T1 and the first node N1. The third transistor T3 may include a first electrode connected to the third electrode of the first transistor T1, a second electrode connected to the second electrode of the first transistor T1, and a third electrode (for example, a gate electrode) connected to the j-th compensating scan line SCLj. The third transistor T3 may be turned on in response to the j-th compensating scan signal SCj, which is received through the j-th compensating scan line SCLj, to connect the third electrode and the second electrode of the first transistor T1, such that the first transistor T1 may be diode-connected.

The fourth transistor T4 is connected between the first initializing voltage line VIL providing the first initializing voltage Vint and the first node N1. The fourth transistor T4 includes a first electrode connected to the first initializing voltage line VIL for transmitting the first initializing voltage Vint, a second electrode connected to the first node N1, and a third electrode (for example, a gate electrode) connected to the j-th initializing scan line SILj. The fourth transistor T4 is turned on in response to the j-th initializing scan signal SIj received through the j-th initializing scan line SILj. The fourth transistor T4, which is turned on, transmits the first initializing voltage Vint to the first node N1 such that a potential (i.e., a potential of the first node N1) of the third electrode of the first transistor T1 is initialized.

The fifth transistor T5 includes a first electrode connected to the first driving voltage line VL1, a second electrode connected to the first electrode of the first transistor T1, and a third electrode (e.g., a gate electrode) connected to the j-th light emitting control line EMLj.

The sixth transistor T6 may include a first electrode connected to the second electrode of the first transistor T1, a second electrode connected to the anode electrode of the light emitting element ED, and a third electrode (for example, a gate electrode) connected to the j-th light emitting control line EMLj.

The fifth and sixth transistors T5 and T6 are simultaneously turned on in response to the j-th light emitting control signal EMj received through the j-th light emitting control line EMLj. The first driving voltage ELVDD applied through the turned-on fifth transistor T5 may be transmitted to the light emitting element ED after being compensated through the diode-connected first transistor T1.

The seventh transistor T7 includes a first electrode connected to the second initializing voltage line VAIL for transmitting the second initializing voltage Vaint, a second electrode connected to the second electrode of the sixth transistor T6, and a third electrode (for example, a gate electrode) connected to the j-th black scan line SBLj. A voltage level of the second initializing voltage Vaint may be lower than or equal to that of the first initializing voltage Vint.

The eighth transistor T8 includes a first electrode connected to the bias voltage line VBL for transmitting the bias voltage Vbias, a second electrode connected to the first electrode of the first transistor T1, and a third electrode (for example, a gate electrode) connected to the j-th black scan line SBLj.

The seventh and eighth transistors T7 and T8 are simultaneously turned on in response to the j-th black scan signal SBj received through the j-th black scan line SBLj. The second initializing voltage Vaint applied through the seventh transistor T7, which is turned on, may be transferred to the anode electrode of the light emitting element ED. Accordingly, the anode electrode of the light emitting element ED may be initialized to the second initializing voltage Vaint. The bias voltage Vbias applied through the eighth transistor T8, which is turned on, may be transmitted to the first electrode of the first transistor T1. Accordingly, the bias voltage Vbias may be periodically applied to the first electrode of the first transistor T1. As a result, the potential difference between the first and second electrodes of the first transistor T1 increases to a specific level or more due to a hysteresis phenomenon, thereby preventing the display quality from being degraded.

A first terminal of the capacitor Cst is connected to the third electrode of the first transistor T1 as described above, and a second terminal (which is opposite to the first terminal) of the capacitor Cst is connected to the first driving voltage line VL1. A cathode electrode of the light emitting element ED may be connected to the second driving voltage line VL2 for transmitting the second driving voltage ELVSS. The voltage level of the second driving voltage ELVSS may be lower than the voltage level of the first driving voltage ELVDD. As an example of the present disclosure, the voltage level of the second driving voltage ELVSS may be lower than the voltage levels of the first and second initializing voltages Vint and Vaint.

FIG. 6 is a waveform diagram for describing an operation of a pixel according to an embodiment of the present disclosure.

Referring to FIGS. 5 and 6, the j-th light emitting control signal EMj has a high level for a non-emission period NEP. During the non-emission period NEP, the j-th initializing scan signal SIj is activated. During an active period AP1 (hereinafter referred to as a “first active period”) of the j-th initializing scan signal SIj, when the j-th initializing scan signal SIj having the high level is applied through the j-th initializing scan line SILj, the fourth transistor T4 is turned on in response to the j-th initializing scan signal SIj having the high level. The first initializing voltage Vint is transmitted to the third electrode of the first transistor T1 through the fourth transistor T4 which is turned on, and the first node N1 is initialized with the first initializing voltage Vint. Accordingly, the first active period AP1 may be defined as an initializing period of the pixel PXij.

Next, when the j-th compensating scan signal SCj is activated, and when the j-th compensating scan signal SCj having the high level is provided through the j-th compensating scan line SCLj, during an active period AP2 (hereinafter referred to as a “second active period”) of the j-th compensating scan signal SCj, the third transistor T3 is turned on. The first transistor T1 is diode-connected and forward-biased by the third transistor T3 which is turned on. The first active period AP1 may not overlap with the second active period AP2.

The j-th write scan signal SWj is activated within the second active period AP2. During an active period AP4 (hereinafter, referred to as a “fourth active period) of the j-th write scan signal SWj, the j-th write scan signal SWj has a low level. A time, in which the j-th write scan signal SWj has an active level within the fourth active period AP4, may be referred to as a scan on time (SOT; gate on time). In other words, as the scan on time is reduced, the scan driver 300 (see FIG. 4) may secure a shorter fourth active period AP4.

During the fourth active period AP4, the second transistor T2 is turned on by the j-th write scan signal SWj having the low level. In this case, the third electrode of the first transistor T1 may receive a compensating voltage “Di-Vth” which is reduced by the threshold voltage Vth of the first transistor T1 from the i-th data signal Di, which is applied through the i-th data line DLi. In other words, a potential of the third electrode of the first transistor T1 may be the compensating voltage “Di-Vth”. The fourth active period AP4 may be overlapped with the second active period AP2. The duration of the second active period AP2 may be longer than the duration of the fourth active period AP4.

The first driving voltage ELVDD and the compensating voltage “Di-Vth” may be applied to opposite terminals of the capacitor Cst, and charges corresponding to the difference in voltage between the first terminal of the capacitor Cst provided with the compensating voltage “Di-Vth” and the second terminal of the capacitor Cst provided with the first driving voltage ELVDD. In this case, a high-level period of the j-th compensating scan signal SCj may be referred to as a “compensating period” of the pixel PXij.

The j-th black scan signal SBj is activated in the second active period AP2 of the j-th compensating scan signal SCj. The j-th black scan signal BSj has the low level during an active period AP3 (hereinafter referred to as a “third active period”) of the j-th black scan signal SBj. During the third active period AP3, the seventh transistor T7 is turned on in response to the j-th black scan signal BSj having the low level, which is applied through the j-th black scan line SBLj. A portion of the driving current Id may be discharged through the seventh transistor T7 as a bypass current Ibp. The third active period AP3 may be overlapped with the second active period AP2. The duration of the second active period AP2 may be longer than the duration of the third active period AP3. The third active period AP3 may precede the fourth active period AP4 and may not be overlapped with the fourth active period AP4.

When the pixel PXij displays a black image, if the minimum driving current of the first transistor T1 flows as the driving current Id which causes the light emitting element ED to emit light, it is difficult for the pixel PXij to properly display the black image. Therefore, according to an embodiment of the present disclosure, the seventh transistor T7 in the pixel PXij may discharge a portion of the minimum driving current of the first transistor T1, as the bypass current lbp, through a current path other than a current path toward the light emitting element ED. In this case, the minimum driving current of the first transistor T1 may refer to a current flowing through the first transistor T1, under the condition that the first transistor T1 is turned off as the gate-source voltage of the first transistor T1 is less than the threshold voltage Vth. Even under the condition that the first transistor T1 is turned off, if the minimum driving current (e.g., a current of 10 pA or less) flowing through the first transistor T1 is transmitted to the light emitting element ED, an image of a black gray scale may be displayed. When the pixel PXij displays the black image, the influence of the bypass current Ibp on the minimum driving current Id is relatively great. To the contrary, when displaying a normal image or a white image, the influence of the bypass current Ibp on the driving current Id is relatively small. Accordingly, when a black image is displayed, a current (i.e., a light emitting current (Ied)) reduced from the driving current ld by the the bypass current Ibp, which flows out through the seventh transistor T7, is provided to the light emitting element ED to make the light emitting element ED a clear expression of the black image. Accordingly, the pixel PXij may implement an accurate black grayscale image using the seventh transistor T7, resulting in an improved contrast ratio.

After the second active period AP2, the j-th light emitting control signal EMj received from the j-th light emitting control line EMLj is shifted from the high level to the low level. The fifth and sixth transistors T5 and T6 are turned on by the j-th light emitting control signal EMj having the low level. In this case, the driving current Id is generated based on a difference between the voltage of the third electrode of the first transistor T1 and the first driving voltage ELVDD. The driving current Id is provided to the light emitting element ED through the sixth transistor T6, such that a current led flows through the light emitting element ED.

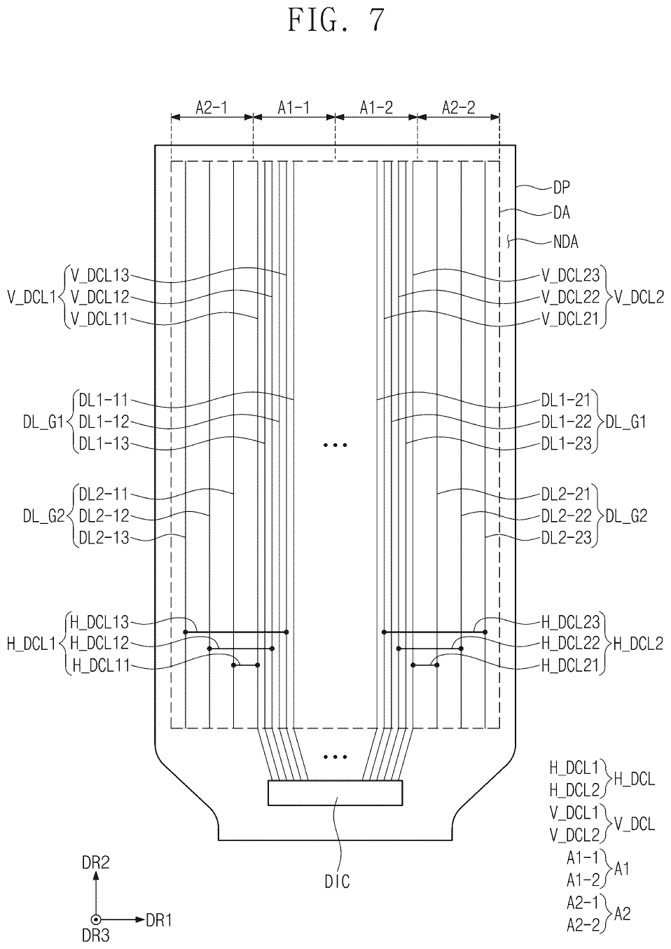

FIG. 7 is a plan view of a display panel according to an embodiment of the present disclosure. In this case, for the convenience of explanation, the scan lines and the light emitting control lines are omitted in FIG. 7, and only data lines are illustrated in FIG. 7.

Referring to FIG. 7, the display panel DP includes a display region DA and a non-display region NDA. The plurality of pixels PX (see FIG. 4) are disposed in the display region DA. A driving chip DIC is mounted on the non-display region NDA.

The driving chip DIC may include the data driver 200 (see FIG. 4).

The data lines DL1 to DLm (see FIG. 3) are connected to the plurality of pixels PX in the display region DA, and connected to the driving chip DIC in the non-display region NDA.

The data lines DL1 to DLm may be grouped into a first group and a second group. The first group includes a plurality of first data lines DL_G1, and the second group includes a plurality of second data lines DL_G2. Each of the plurality of first data lines DL_G1 is arranged in the first direction DR1, and each of the plurality of second data lines DL_G2 is arranged in the first direction DR1. The plurality of first data lines DL_G1 are spaced apart from the plurality of second data lines DL_G2 in the first direction DR1.

The plurality of first data lines DL_G1 are connected to the pixel driving circuit P_PD (see FIG. 5) for a first group of pixels among the plurality of pixels PX, and the plurality of second data lines DL_G2 are connected to the pixel driving circuit P_PD for a second group of pixels among the plurality of pixels PX. The first group of pixels and the first data lines DL_G1 are disposed in a first region A1, and the second group of pixels and the second data lines DL_G2 are disposed in a second region A2. The first region A1 includes a (1-1)-th region A1-1 defined at a first side based on a central line of the display panel DP, which is parallel to the second direction DR2, and a (1-2)-th region defined at a second side based on the central line. The second region A2 includes a (2-1)-th region A2-1 interposed between the (1-1)-th region A1-1 and the non-display region NDA and a (2-2)-th region A2-2 interposed between the (1-2)-th region A1-2 and the non-display region NDA.

The plurality of first data lines DL_G1 include (1-1)-th data lines DL1-11 to DL1-13 disposed in the (1-1)-th region A1-1 and (1-2)-th data lines DL1-21 to DL1-23 disposed in the (1-2)-th region A1-2. The plurality of second data lines DL_G2 include (2-1)-th data lines DL2-11 to DL2-13 disposed in the (2-1)-th region A2-1 and (2-2)-th data lines DL2-21 to DL2-23 disposed in the (2-2)-th region A2-2. The (1-1)-th data lines DL1-11 to DL1-13 and the (1-2)-th data lines DL1-21 to DL1-23 are connected to the driving chip DIC. Although FIG. 7 illustrates that the (1-1)-th data lines DL1-11 to DL1-13 and the (1-2)-th data lines DL1-21 to DL1-23 are connected to the same driving chip DIC, the present disclosure is not limited thereto. For example, the (1-1)-th data lines DL1-11 to DL1-13 and the (1-2)-th data lines DL1-21 to DL1-23 may be connected to mutually different diving chips, respectively.

The display panel DP may further include data connecting lines to connect the second data lines DL_G2 to the driving chip DIC. The data connecting lines may include a plurality of vertical connecting lines V_DCL extending in the second direction DR2 along the first data lines DL_G1 and a plurality of horizontal connecting lines H_DCL extending in the first direction DR1.

The plurality of horizontal connecting lines H_DCL include first horizontal connecting lines H_DCL11 to H_DCL13 and second horizontal connecting lines H_DCL21 to H_DCL23. The first horizontal connecting lines H_DCL11 to H_DCL13 may be connected to (2-1)-th data lines DL2-11 to DL2-13, and second horizontal connecting lines H_DCL21 to H_DCL23 may be connected to (2-2)-th data lines DL2-21 to DL2-23. The plurality of vertical connecting lines V_DCL include first vertical connecting lines V_DCL11 to V_DCL13 and second vertical connecting lines V_DCL21 to V_DCL23. The first vertical connecting lines V_DCL11 to V_DCL13 may be connected to first horizontal connecting lines H_DCL11 to H_DCL13, and the second vertical connecting lines V_DCL21 to V_DCL23 may be connected to second horizontal connecting lines H_DCL21 to H_DCL23.

Accordingly, the first vertical connecting lines V_DCL11 to V_DCL13 are electrically connected to the (2-1)-th data lines DL2-11 to DL2-13 through the first horizontal connecting lines H_DCL11 to H_DCL13. The second vertical connecting lines V_DCL21 to V_DCL23 are electrically connected to the (2-2)-th data lines DL2-21 to DL2-23 through the second horizontal connecting lines H_DCL21 to H_DCL23.

The first vertical connecting lines V_DCL11 to V_DCL13 and the (1-1)-th data lines DL1-11 to DL1-13 may be alternately and repeatedly arranged in the (1-1)-th region A1-1. The second vertical connecting lines V_DCL21 to V_DCL23 and the (1-2)-th data lines DL1-21 to DL1-23 may be alternately and repeatedly arranged in the (1-2)-th region A1-2.

Some of the vertical connecting lines V_DCL and the plurality of horizontal connecting lines H_DCL may be disposed in the display region DA. In other words, some of data lines connecting the second data lines DL_G2 to the driving chip DIC are disposed in the display region DA. Accordingly, an area of a region occupied by the data connecting lines may be reduced in the non-display region NDA, thereby reducing the dead space of the display panel DP.

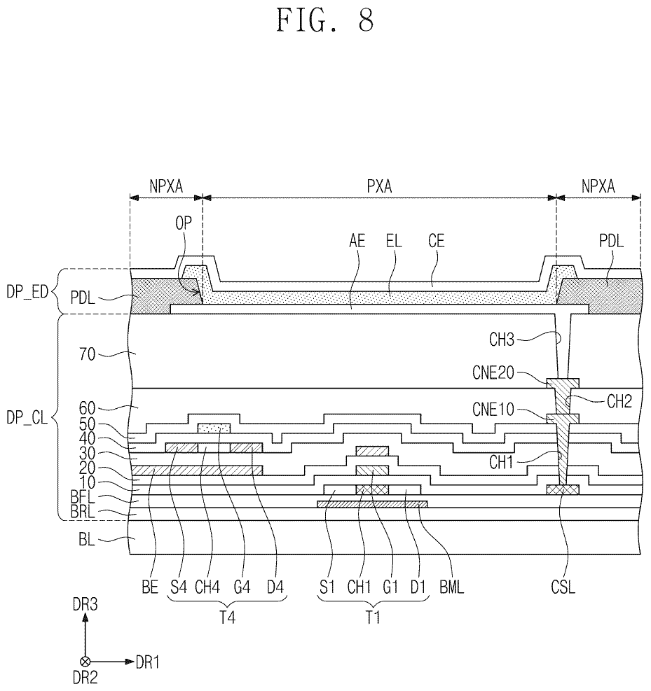

FIG. 8 is a cross-sectional view of a display panel according to an embodiment of the present disclosure.

Referring to FIG. 8, the display panel DP may include the base layer BL, the circuit layer DP_CL, and the element layer DP_ED.

The base layer BL may include a synthetic resin layer. The synthetic resin layer may include a thermosetting resin material. The synthetic resin layer may include a polyimide-based resin layer. However, the material of the base layer BL is not particularly limited thereto. For example, the synthetic resin layer in the base layer BL may include at least one of acrylate-based resin, methacrylate-based resin, polyisoprene-based resin, vinyl-based resin, epoxy-based resin, urethane-based resin, cellulose-based resin, siloxane-based resin, polyamide-based resin, and perylene-based resin. In addition, the base layer BL may include a glass substrate, a metal substrate, or an organic/inorganic composite substrate.

At least one inorganic layer is formed on the base layer BL. The inorganic layer may include at least one of aluminum oxide, titanium oxide, silicon oxide, silicon oxy nitride, zirconium oxide, or hafnium oxide. The inorganic layer may have a multi-layer structure. The multiple inorganic layers may include a barrier layer BRL and/or a buffer layer BFL, which will be described later. The barrier layer BRL and the buffer layer BFL may be disposed selectively.

The circuit layer DP_CL may include the barrier layer BRL and/or the buffer layer BFL. The barrier layer BRL prevents foreign substances from being introduced from the outside. The barrier layer BRL may include a silicon oxide layer and/or a silicon nitride layer. The silicon oxide layer may include a plurality of silicon oxide layers, and the silicon nitride layer may include a plurality of silicon nitride layers. The silicon oxide layers and the silicon nitride layers may be alternately stacked.

The lower metal layer BML may be disposed on the barrier layer BRL.

The lower metal layer BML may be overlapped with the first transistor T1, when viewed in a plan view. The lower metal layer BML may block an external light from reaching the first transistor T1. The lower metal layer BML may be provided with a constant voltage or a signal to prevent the pixel driving circuits P_PD from being damaged due to electrostatic discharge (ESD).

The lower metal layer BML may include a reflective metal. For example, the lower conductive layer BCL1 may include titanium (Ti), molybdenum (Mo), an alloy containing molybdenum (Mo), aluminum (Al), an alloy containing aluminum (Al), an aluminum nitride (AlN), tungsten (W), a tungsten nitride (WN), or copper (Cu).

The buffer layer BFL may be disposed on the barrier layer BRL. The buffer layer BFL may cover the lower metal layer BML. The buffer layer BFL improves a bonding force between the barrier layer BRL and a semiconductor pattern and/or a conductive pattern. The buffer layer BFL may include a silicon oxide layer and a silicon nitride layer. The silicon oxide layer and the silicon nitride layer may be alternately stacked.

The semiconductor pattern is disposed on the buffer layer BFL. A semiconductor pattern directly disposed on the buffer layer BFL is referred to as a first semiconductor pattern. The first semiconductor pattern may include a silicon semiconductor. The first semiconductor pattern may include poly silicon. However, the present disclosure is not limited thereto. For example, the first semiconductor pattern may include amorphous silicon.

Although FIG. 8 illustrates a portion of the first semiconductor pattern included in the first transistor T1, the first semiconductor pattern may be additionally disposed in another region of the pixels PXij, for example, in a region for the second transistor T2, or the fifth to eighth transistors T5-T8 (see FIG. 5). The first semiconductor pattern may have an electrical property varied depending on the doping state. The first semiconductor pattern may include a doping region and a non-doping region. The doping region may be doped with an N-type dopant or a P-type dopant. A P-type transistor includes a doping region doped with the P-type dopant, and an N-type transistor includes a doping region doped with the N-type dopant.

The doping region has higher conductivity than the non-doping region, and substantially functions as an electrode or a signal line. The non-doping region may correspond to an active (or channel) of a transistor. In other words, a portion of the first semiconductor pattern may be the active of the transistor, another portion of the first semiconductor pattern may be a source or drain of the transistor, and still another portion of the first semiconductor pattern may be a connecting signal line (or connecting electrode).

A first electrode S1, a channel part CH1, and a second electrode D1 of the first transistor T1 are formed in the first semiconductor pattern. The first electrode S1 and the second electrode D1 of the first transistor T1 may be disposed in opposite sides of the channel part CH1.

The first semiconductor pattern may further include a portion of a connecting signal line CSL. Although not illustrated separately, the connecting signal line CSL may be electrically connected to the second electrode of the sixth transistor T6 (see FIG. 6), when viewed in a plan view.

A first insulating layer 10 is disposed on the buffer layer BFL. The first insulating layer 10 may commonly overlap the plurality of pixels PX (see FIG. 4) and cover the first semiconductor pattern. The first insulating layer 10 may be an inorganic layer and/or an organic layer and may have a single-layer or multi-layer structure. The first insulating layer 10 may include at least one of an aluminum oxide, a titanium oxide, a silicon oxide, a silicon oxynitride, a zirconium oxide, and a hafnium oxide. According to an embodiment, the first insulating layer 10 may be a silicon oxide layer in a single layer. In addition to the first insulating layer 10, the insulating layer of the circuit layer DP_CL, which is to be described below, may be an inorganic layer and/or an organic layer, and may have a single-layer structure or a multi-layer structure. The inorganic layer may include at least one of the above-described materials.

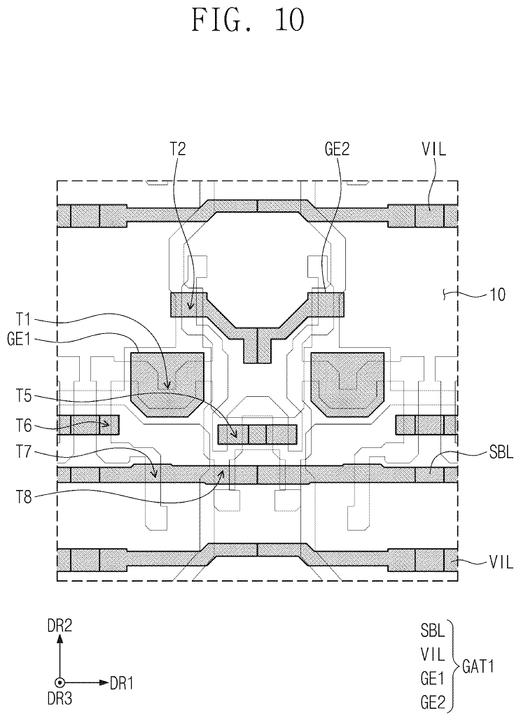

A third electrode G1 of the first transistor T1 is disposed on the first insulating layer 10. The third electrode G1 may be a portion of the first gate pattern layer GAT1 (see FIG. 10). The third electrode G1 of the first transistor T1 overlaps the channel part CH1 of the first transistor T1. In the process of doping the first semiconductor pattern, the third electrode G1 of the first transistor T1 may function as a mask.

A second insulating layer 20 is disposed on the first insulating layer 10 and cover the third electrode G4. The second insulating layer 20 may commonly overlap the plurality of pixels PX. The second insulating layer 20 may be an inorganic layer and/or an organic layer and may have a single-layer structure or multi-layer structure. According to an embodiment, the second insulating layer 20 may include a silicon oxide layer in a single layer.

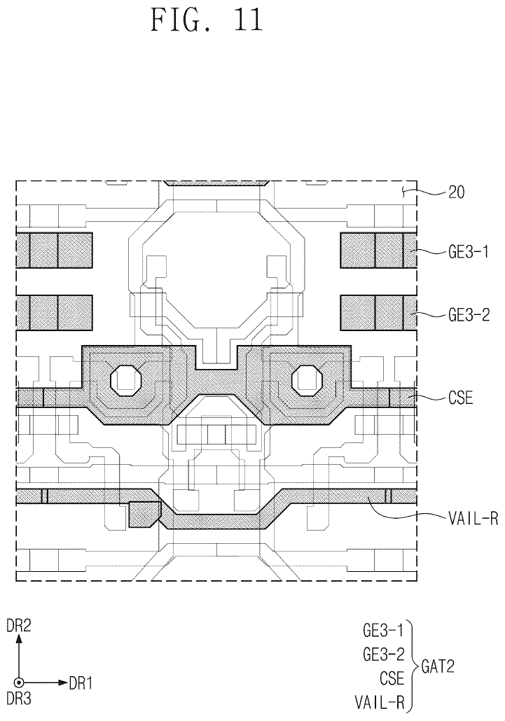

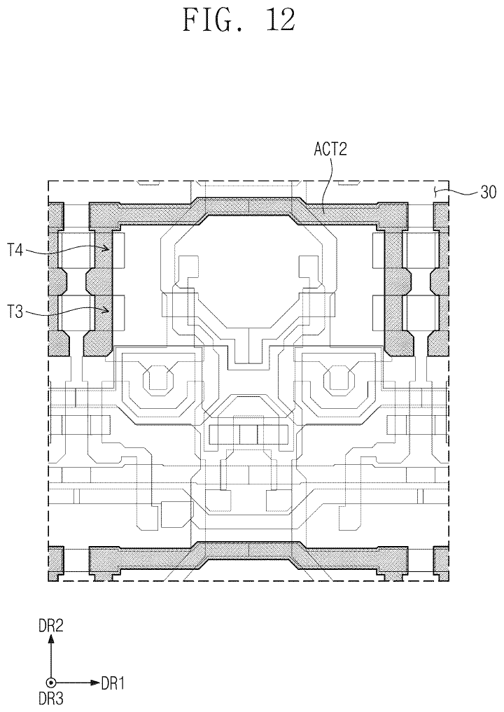

An upper electrode and a lower electrode BE may be disposed on the second insulating layer 20. The upper electrode may be overlapped with the third electrode G1 of the first transistor T1. The lower electrode BE may be overlapped with a second semiconductor pattern of a second transistor to be described later. The lower electrode BE may be referred to as a bottom gate of the fourth transistor T4. The upper electrode and the lower electrode BE may be parts of the second gate pattern layer GAT2 (see FIG. 11). A portion of the third electrode G1 and the upper electrode overlapped with the portion of the third electrode G1 may define the capacitor Cst (see FIG. 5). According to an embodiment of the present disclosure, the upper electrode may be omitted. Although FIG. 8 illustrates a structure in which the lower electrode BE and the upper electrode are disposed on the same layer, the present disclosure is not limited thereto. For example, the lower electrode BE may be a portion of a first gate pattern layer GAT1 (see FIG. 10). In this case, the lower electrode BE and the third electrode G4 of the first transistor T1 may be disposed on the same layer.

According to an embodiment of the present disclosure, the second insulating layer 20 may be substituted to an insulating pattern. The upper electrode and the lower electrode BE are disposed on an insulating pattern. The upper electrode and the lower electrode BE may serve as a mask for forming the insulating pattern from the second insulating layer 20.

A third insulating layer 30 is disposed on the second insulating layer 20 and cover the upper electrode and the lower electrode BE. According to an embodiment, the third insulating layer 30 may include a silicon oxide layer in a single layer. A semiconductor pattern is disposed on the third insulating layer 30. Hereinafter, a semiconductor pattern directly disposed on the third insulating layer 30 may be defined as a second semiconductor pattern. The second semiconductor pattern may include an oxide semiconductor. The oxide semiconductor may include a crystalline or amorphous oxide semiconductor. For example, the oxide semiconductor may include metal oxide of zinc (Zn), indium (In), gallium (Ga), tin (Sn), or titanium (Ti), or a mixture of a metal, such as zinc (Zn), indium (In), gallium (Ga), tin (Sn), or titanium (Ti), and an oxide thereof. The oxide semiconductors may include indium-tin oxide (ITO), indium-gallium-zinc oxide (IGZO), zinc oxide (ZnO), indium-zinc oxide (IZO), zinc-indium oxide (ZIO), indium oxide (InO), titanium oxide (TiO), indium-zinc-tin oxide (IZTO), or zinc-tin oxide (ZTO).

Although FIG. 8 illustrates a portion of the second semiconductor pattern included in the fourth transistor T4, the second semiconductor pattern may be additionally disposed in another region of the pixels PXij, for example, in a region for the third transistor T3. The second semiconductor pattern may include a plurality of regions that are distinguished depending on whether the metal oxide is reduced. A region (hereinafter referred to as a “reduction region”) in which the metal oxide is reduced has higher conductivity than a region (hereinafter referred to as a “non-reduction region”) in which the metal oxide is not reduced. The reduction region may function as an electrode or a signal line. The non-reduction region may correspond to a channel portion of a transistor. In other words, the portion of the second semiconductor pattern may be a channel portion of a transistor, and another portion of the second semiconductor pattern may be a first electrode or a second electrode of the transistor.

FIG. 8 illustrates a fourth transistor T4 of the semiconductor pattern of the pixel driving circuit P_PD. A first electrode S4, a channel part CH4, and a second electrode D4 of the fourth transistor T4 are formed in the second semiconductor pattern. According to an embodiment of the present disclosure, the second semiconductor pattern may include a metal oxide. The first electrode S4 and the second electrode D4 include metal reduced from a metal oxide semiconductor. The first electrode S4 and the second electrode D4 may include a metal layer having a specific thickness from a top surface of the second semiconductor pattern, and may include the reduced metal.

A fourth insulating layer 40 is disposed to cover the first electrode S4, the channel part CH4, and the second electrode D4 of the fourth transistor T4. A third electrode G4 of the fourth transistor T4 is disposed on the fourth insulating layer 40. According to an embodiment, the third electrode G4 of the fourth transistor T4 may be a portion of the third gate pattern layer GAT3 (see FIG. 13). The third electrode G4 of the fourth transistor T4 may be referred to as a top gate of the fourth transistor T4. The third electrode G4 of the fourth transistor T4 is overlapped with the channel part CH4 of the fourth transistor T4. The third electrode G4 of the fourth transistor T4 may be overlapped with the lower electrode BE, when viewed in a plan view, and may be connected to the lower electrode BE through a contact hole formed through the third and fourth insulating layers 30 and 40. In other words, the third electrode G4 of the fourth transistor T4 may be electrically connected to the lower electrode BE.

A fifth insulating layer 50 is disposed on the fourth insulating layer 40 and cover the third electrode G4 of the fourth transistor T4. According to an embodiment, the fifth insulating layer 50 may include a silicon oxide layer and/or a silicon nitride layer. The fifth insulating layer 50 may include a plurality of silicon oxynitride layers and silicon nitride layers alternately stacked one another.

At least one insulating layer is further disposed on the fifth insulating layer 50. According to an embodiment, a sixth insulating layer 60 may be disposed on the fifth insulating layer 50. The sixth insulating layer 60 may be an organic layer, and may have a single-layer structure or a multi-layer structure. The sixth insulating layer 60 may be a polyimide-based resin layer in a single layer. However, the present disclosure is not limited thereto. For example, the sixth insulating layer 60 may include at least one of acrylic resin, methacrylic resin, polyisoprene, vinyl resin, epoxy resin, urethane-based resin, cellulosic resin, siloxane-based resin, polyamide resin, or perylene-based resin.

A first connecting electrode CNE10 may be disposed on the fifth insulating layer 50. The first connecting electrode CNE10 is connected to the connecting signal line CSL through a first contact hole CH1 formed through the first to fifth insulating layers 10 to 50. A second connecting electrode CNE20 may be connected to the first connecting electrode CNE10 through a second contact hole CH2 formed through the sixth insulating layer 60.

The first connecting electrode CNE10 may be a portion of a first data metal pattern, and the second connecting electrode CNE20 may be a portion of a second data metal pattern.

The horizontal connecting lines H_DCL (see FIG. 7) may be disposed on a same layer (that is, the fifth insulating layer 50) as the first connecting electrode CNE10. However, the present disclosure is not limited thereto. The horizontal connecting lines H_DCL may be disposed on a same layer (that is, the first insulating layer 10) as the first electrode G1 of the first transistor T1.

The vertical connecting lines V_DCL (see FIG. 7), and the first and second data lines DL_GL1 and DL_G2 (see FIG. 7) may be disposed on a same layer (that is, the sixth insulating layer 60) as the second connecting electrode CNE20.

A seventh insulating layer 70 is further disposed on the sixth insulating layer 60 and cover the vertical connecting lines V_DCL (FIG. 7), the first and second data lines DL_G1 and DL_G2, and the second connecting electrode CNE20. A third contact hole CH3 may be provided in the seventh insulating layer 70 to extend to a portion of the second connecting electrode CNE20.

The element layer DP_ED is disposed on the circuit layer DP_CL. The element layer DP_ED may include an anode electrode AE of the light emitting element ED. As illustrated in FIG. 8, the anode electrode AE of the light emitting element ED may be connected to the second connecting electrode CNE20 through the third contact hole CH3 formed through the seventh insulating layer 70. Although FIG. 8 illustrates that the anode electrode AE is directly connected to the second connecting electrode CNE20, the present disclosure is not limited thereto. For example, the circuit layer DP_CL may further include a bridge electrode which connects the anode electrode AE to the second connecting electrode CNE20.

The element layer DP_ED further includes a pixel defining layer PDL disposed on the circuit layer DP_CL. The pixel defining layer PDL may include an opening OP that is defined to correspond to the light emitting element ED. The opening OP extends to at least a portion of the anode electrode AE of the light emitting element ED. The opening OP of the pixel defining layer PDL may define a light emitting region PXA. For example, the plurality of pixels PX (see FIG. 4) may be arranged on a plane of the display panel DP (see FIG. 4) in a specific rule. A region in which the plurality of pixels PX are disposed may be defined as a pixel region, and the pixel region may include the light emitting region PXA and a non-light emitting region NPXA adjacent to the light emitting region PXA. The non-light emitting region NPXA may surround the light emitting region PXA.

A light emitting layer EL is disposed in the opening OP of the pixel defining layer PDL. According to an embodiment, although the patterned light emitting layer EL is illustrated, the present disclosure is not limited thereto. For example, a common light emitting layer may be commonly disposed in the plurality of pixels PX. In this case, the common light emitting layer may generate a white light or a blue light. A cathode electrode CE is disposed on the light emitting layer EL. The cathode electrode CE is commonly disposed in the plurality of pixels PX.

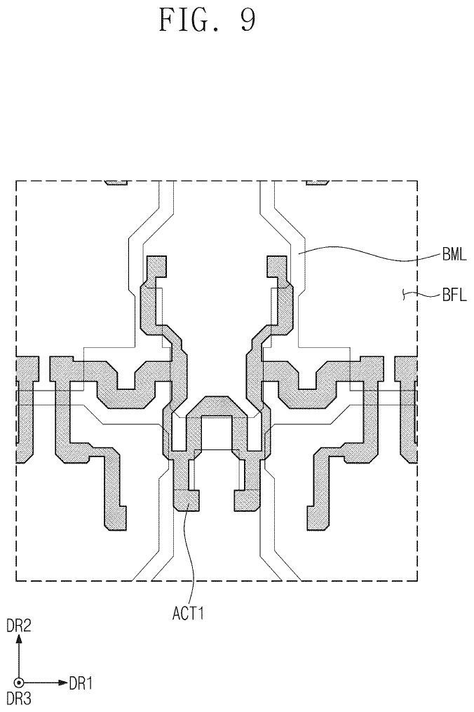

FIG. 9 is a plan view illustrating a portion of a circuit layer according to an embodiment of the present disclosure.

Referring to FIG. 9, the lower metal layer BML may be formed on the barrier layer BRL (see FIG. 8). The low metal layer BML may be disposed under at least one of the first to eighth transistors T1 to T8 (see FIG. 5), provided in each pixel driving circuit P_PD (see FIG. 5), to block light incident from the outside to the first to eighth transistors T1 to T8 (see FIG. 5).

The buffer layer BFL may cover the lower metal layer BML. The buffer layer BFL may be disposed on the barrier layer BRL (see FIG. 8). A first semiconductor pattern ACT1 may be disposed on the buffer layer BFL. The first semiconductor pattern ACT1 may include a first material. The first material may include a silicon semiconductor. For example, the first semiconductor pattern ACT1 may include polysilicon LTPS.

The first semiconductor pattern ACT1 may include a first semiconductor pattern of each of some transistors T1, T2, and T5 to T8 (see FIG. 5) included in the pixel driving circuit P_PD (see FIG. 5). For example, the first semiconductor pattern ACT1 may include the first electrode S1, the channel part CH1, and the second electrode D1 of the first transistor T1 (see FIG. 8).

FIG. 10 is a plan view illustrating a portion of a circuit layer according to an embodiment of the present disclosure.

Referring to FIGS. 5 and 10, the first semiconductor pattern ACT1 (see FIG. 9), and the lower metal layer BML (see FIG. 9) may be covered by the first insulating layer 10.

The first gate pattern layer GAT1 may be disposed on the first insulating layer 10. The first gate pattern layer GAT1 may include a metal, an alloy, a conductive metal oxide, or a transparent conductive material. For example, the first gate pattern layer GAT1 may include silver (Ag), an alloy containing silver (Ag), molybdenum (Mo), an alloy containing molybdenum (Mo), aluminum (Al), an alloy containing aluminum (Al), an aluminum nitride (AlN), tungsten (W), a tungsten nitride (WN), copper (Cu), indium tin oxide (ITO), or indium zinc oxide (IZO), but the present disclosure is not limited thereto.

The first gate pattern layer GAT1 may include a black scan line SBL, a first gate electrode GE1, a second gate electrode GE2, and a first initializing voltage line VIL.

The black scan line SBL may extend in the first direction DR1. The black scan line SBL may correspond to the j-th black scan line SBLj of FIG. 5. A black scan signal SBj may be provided through the black scan line SBL. When viewed in a plan view, the black scan line SBL may be overlapped with at least a portion of the first semiconductor pattern ACT1. The black scan line SBL may form the seventh transistor T7 and the eighth transistor T8 together with the first semiconductor pattern ACT1.

The first initializing voltage line VIL may extend in the first direction DR1. The first initializing voltage Vint (see FIG. 5) may be applied through the first initializing voltage line VIL. The first initializing voltage line VIL may be spaced apart from the black scan line SBL in the second direction DR2, when viewed in a plan view. The first gate electrode GE1 may be formed in an island shape. The first gate electrode GE1 may be overlapped with at least a portion of the first semiconductor pattern ACT1, when viewed in a plan view. The first gate electrode GE1 may form the first transistor T1 together with the first semiconductor pattern ACT1. The first gate electrode GE1 may be a component substantially the same as the third electrode G1 illustrated in FIG. 8.

The second gate electrode GE2 may be formed in an island shape. The second gate electrode GE2 may be overlapped with at least a portion of the first semiconductor pattern ACT1, when viewed in a plan view. The second gate electrode GE2 may form the second transistor T2 together with the first semiconductor pattern ACT1.

The first gate pattern layer GAT1 may include a plurality of gate electrodes. Each of the gate electrodes may be formed in an island shape. Each of the gate electrodes may form the fifth transistor T5 and the sixth transistor T6 together with the first semiconductor pattern ACT1.

FIG. 11 is a plan view illustrating a portion of a circuit layer according to an embodiment of the present disclosure.

Referring to FIGS. 5 and 11, the second insulating layer 20 may cover the first gate pattern layer GAT1 (see FIG. 10). The second insulating layer 20 may be disposed on the first insulating layer 10 (see FIG. 10). The second gate pattern layer GAT2 may be formed on the second insulating layer 20. The second gate pattern layer GAT2 may include a metal, an alloy, a conductive metal oxide, or a transparent conductive material.

The second gate pattern layer GAT2 may include third gate electrodes GE3-1 and GE3-2, a capacitor electrode CSE, and a red initializing voltage line VAIL-R.

Each of the third gate electrodes GE3-1 and GE3-2 may be formed in an island shape. The third gate electrodes GE3-1 and GE3-2 may be a component substantially the same as the lower electrode BE illustrated in FIG. 8.

The third gate electrodes GE3-1 and GE3-2 may include a (3-1)-th gate electrode GE3-1 and a (3-2)-th gate electrode GE3-2. The (3-1)-th gate electrode GE3-1 may form a bottom gate of the fourth transistor T4. The (3-2)-th gate electrode GE3-2 may form a bottom gate of the third transistor T3.

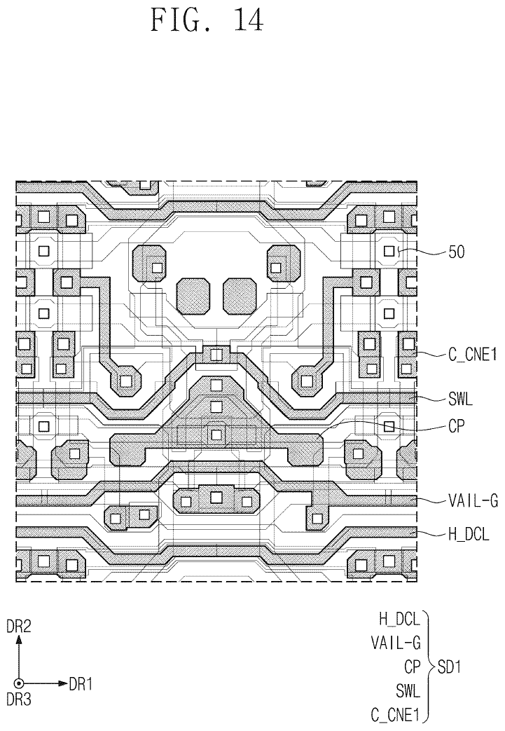

The capacitor electrode CSE may extend in the first direction DR1. The capacitor electrode CSE may be overlapped with the first gate electrode GE1 (see FIG. 10), when viewed in a plan view. The capacitor electrode CSE may be a component substantially the same as the upper electrode illustrated in FIG. 8. The first driving voltage ELVDD may be provided to the capacitor electrode CSE. For example, the capacitor electrode CSE may be connected to the first driving voltage line VL1 in the non-display region NDA (see FIG. 4). However, this is provided only for the illustrative purpose. The connection relationship between the capacitor electrode CSE according to an embodiment of the present disclosure and the first driving voltage line VL1 is not limited thereto. For example, the capacitor electrode CSE may be connected to the first driving voltage line VL1 through a connecting pattern CP (see FIG. 14) to be described later.

A red initializing voltage line VAIL-R may extend in the first direction DR1. The red initializing voltage line VAIL-R may be included in the second initializing voltage line VAIL. The second initializing voltage Vaint may be provided to a pixel which emits a red light through the red initializing voltage line VAIL-R.

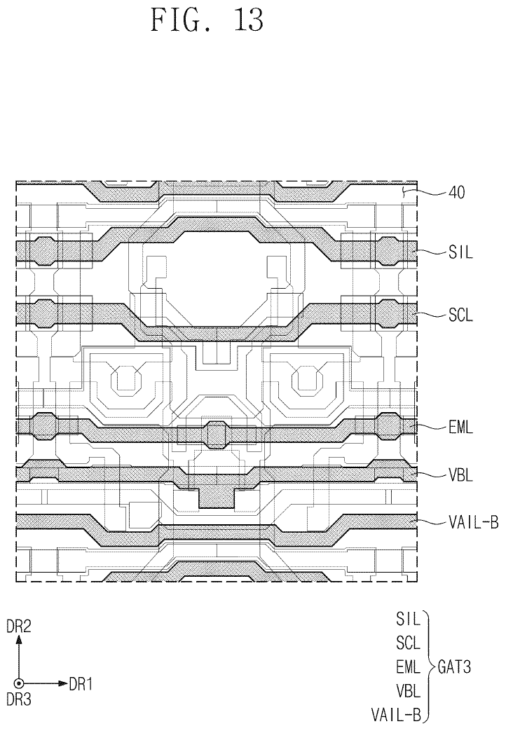

FIG. 12 is a plan view illustrating a portion of a circuit layer according to an embodiment of the present disclosure.

Referring to FIG. 12, the third insulating layer 30 may cover the second gate pattern layer GAT2 (see FIG. 11). The third insulating layer 30 may be disposed on the second insulating layer 20 (see FIG. 10).

A second semiconductor pattern ACT2 may be disposed on the third insulating layer 30. The second semiconductor pattern ACT2 may be disposed on a layer different from a layer for the first semiconductor pattern ACT1 (see FIG. 9). The second semiconductor pattern ACT2 may not overlap the first semiconductor pattern ACT1 (see FIG. 9), when viewed in a plan view. The second semiconductor pattern ACT2 may include a second material. The second material may include an oxide semiconductor. In other words, the second semiconductor pattern ACT2 may include a material different from a material of the first semiconductor pattern ACT1 (see FIG. 9).

The second semiconductor pattern ACT2 may include a second semiconductor pattern of some transistors T3 and T4 included in the pixel driving circuit P_PD (see FIG. 5). For example, the second semiconductor pattern ACT2 may include the first electrode S4, the channel part CH4, and the second electrode D4 of the fourth transistor T4 (see FIG. 8).

FIG. 13 is a plan view illustrating a portion of a circuit layer according to an embodiment of the present disclosure.

Referring to FIGS. 5 and 13, the fourth insulating layer 40 may cover the second semiconductor pattern ACT2 (see FIG. 12). The fourth insulating layer 40 may be disposed on the third insulating layer 30. The third gate pattern layer GAT3 may be disposed on the fourth insulating layer 40. The third gate pattern layer GAT3 may include a metal, an alloy, a conductive metal oxide, or a transparent conductive material.

The third gate pattern layer GAT3 may include an initializing scan line SIL, a compensating scan line SCL, a light emitting control line EML, a bias voltage line VBL, and a blue initializing voltage line VAIL-B.

The initializing scan line SIL may extend in the first direction DR1. The initializing scan line SIL may correspond to the j-th initializing scan line SILj illustrated in FIG. 5. The initializing scan signal SIj may be applied through the initializing scan line SIL.

The initializing scan line SIL may be overlapped with at least a portion of the second semiconductor pattern ACT2 (see FIG. 12), when viewed in a plan view. The initializing scan line SIL may form the fourth transistor T4 together with the second semiconductor pattern ACT2 (see FIG. 12).

A portion of the initializing scan line SIL may be overlapped with the (3-1)-th gate electrode GE3-1 (see FIG. 11), when viewed in a plan view. The initializing scan line SIL may be disposed on a layer different from a layer for the first gate electrode GE1 (see FIG. 10).

The compensating scan line SCL may extend in the first direction DR1. The compensating scan line SCL may be spaced apart from the initializing scan line SIL in the second direction DR2. The compensating scan line SCL may correspond to the j-th compensating scan line SCLj illustrated in FIG. 5. The compensating scan signal SCj may be applied through the compensating scan line SCL.

The compensating scan line SCL may be overlapped with at least a portion of the second semiconductor pattern ACT2 (see FIG. 12), when viewed in a plan view. The compensating scan line SCL may form the third transistor T3 together with the second semiconductor pattern ACT2 (see FIG. 12).

A portion of the compensating scan line SCL may be overlapped with the (3-2)-th gate electrode GE3-2 (see FIG. 11), when viewed in a plan view.

The light emitting control line EML may extend in the first direction DR1. The light emitting control line EML may be spaced apart from the compensating scan line SCL in the second direction DR2. The light emitting control line EML may correspond to a j-th light emitting control line EMLj illustrated in FIG. 5. The light emitting control signal EMj may be applied through the light emitting control line EML.

The light emitting control line EML may be overlapped with at least a portion of the first semiconductor pattern ACT1 (see FIG. 9), when viewed in a plan view. The light emitting control line EML may be overlapped with a portion, which corresponds to the fifth transistor T5 and the sixth transistor T6 of the first semiconductor pattern ACT1 (see FIG. 9).

The bias voltage line VBL may extend in the first direction DR1. The bias voltage Vbais may be applied through the bias voltage line VBL. The bias voltage line VBL may be overlapped with the first semiconductor pattern ACT1 (see FIG. 9), when viewed in a plan view. The bias voltage line VBL may be overlapped with the black scan line SBL (see FIG. 10), when viewed in a plan view.

The blue initializing voltage line VAIL-B may extend in the first direction DR1. The blue initializing voltage line VAIL-B may be included in the second initializing voltage line VAIL. The second initializing voltage Vaint may be applied to a pixel which emits a blue light through the blue initializing voltage line VAIL-B. For example, the first voltage level of the second initializing voltage Vaint applied to the blue initializing voltage line VAIL-B may be different from the second voltage level of the second initializing voltage Vaint applied to the red initializing voltage line VAIL-R (see FIG. 11). However, this is provided only for the illustrative purpose. For example, the first voltage level and the second voltage level according to an embodiment of the present disclosure are not limited thereto. For example, the first voltage level and the second voltage level may be equal to each other.

FIG. 14 is a plan view illustrating a portion of a circuit layer according to an embodiment of the present disclosure.

Referring to FIGS. 5, and 9 to 14, the fifth insulating layer 50 may cover the third gate pattern layer GAT3. The fifth insulating layer 50 may be disposed on the fourth insulating layer 40 (see FIG. 13). The first data pattern layer SD1 may be disposed on the fifth insulating layer 50. The first data pattern layer SD1 may include, for example, a metal, an alloy, a conductive metal oxide, or a transparent conductive material.

The first data pattern layer SD1 may include a horizontal connecting line H_DCL, a green initializing voltage line VAIL-G, the connecting pattern CP, a write scan line SWL, and a plurality of first connecting electrode patterns C_CNE1.

The horizontal connecting line H_DCL may extend in the first direction DR1. The horizontal connecting line H_DCL may be connected to a relevant data line DLi and a relevant vertical connecting line V_DCL (see FIG. 7).

The green initializing voltage line VAIL-G may extend in the first direction DR1. The green initializing voltage line VAIL-G may be included in the second initializing voltage line VAIL. The second initializing voltage Vaint may be applied to a pixel which emits a green light through the green initializing voltage line VAIL-G. For example, the third voltage level of the second initializing voltage Vaint applied to the green initializing voltage line VAIL-G may be different from the second voltage level of the second initializing voltage Vaint applied to the blue initializing voltage line VAIL-B. However, this is provided only for the illustrative purpose. For example, the first voltage level to the third voltage level according to an embodiment of the present disclosure may be equal to each other.

The connecting pattern CP may be provided in an island shape. The connecting pattern CP may be overlapped with at least a portion of the first semiconductor pattern ACT1, when viewed in a plan view. For example, the connecting pattern CP may be connected to the first semiconductor pattern ACT1 forming the fifth transistor T5 through a contact hole.

The connecting pattern CP may be overlapped with the capacitor electrode CSE, when viewed in a plan view. The connecting pattern CP may not be connected to the capacitor electrode CSE through the contact hole. However, this is provided only for the illustrative purpose. For example, according to an embodiment of the present disclosure, the capacitor electrode CSE may be connected to the first driving voltage line VL1 through the connecting pattern CP, and the capacitor electrode CSE may receive the first driving voltage ELVDD.

The connecting pattern CP may not overlap with the compensating scan line SCL and the second transistor T2, when viewed in a plan view.

The write scan line SWL may extend in the first direction DR1. The write scan line SWL may be spaced apart from the connecting pattern CP in the second direction DR2. The write scan line SWL may be connected to the second gate electrode GE2 through the contact hole. The write scan line SWL may correspond to the j-th write scan line SWLj illustrated in FIG. 5. The write scan signal SWj may be applied through the write scan line SWL.

The second transistor T2 may be turned on in response to the write scan signal SWj provided through the write scan line SWL. The second transistor T2 may provide the data signal Di to the first transistor T1 functioning as the driving transistor.

The write scan line SWL, the initializing scan line SIL, and the first gate electrode GE1 may be disposed on different layers from each other.

The write scan line SWL may be disposed on a layer different from the layer for the initializing scan line SIL, the light emitting control line EML, and the compensating scan line SCL.

The write scan line SWL may be overlapped with at least a portion of the first gate electrode GE1 when viewed in a plan view.

The write scan line SWL may be overlapped with at least a portion of the capacitor electrode CSE, when viewed in a plan view.

A first resistance of the first data pattern layer SD1 may be lower than a second resistance of the first gate pattern layer GAT1. For example, the second resistance may have a value at least 10 times greater than that of the first resistance.

If the write scan line may be formed in the first gate pattern layer GAT1, the write scan signal may be delayed due to the resistance of the first gate pattern layer GAT1. Accordingly, a scan-on time of the write scan signal may be reduced. Accordingly, the level of the write scan signal may not be sufficiently switched from a non-active level to an active level during a fourth active period AP4 (see FIG. 6). However, according to the present disclosure, since the first data pattern layer SD1 may include the write scan line SWL, the resistance of the write scan line SWL may be reduced, and the delay of the write scan signal SWj may be reduced. The scan-on time of the write scan signal SWj may be sufficiently ensured. Accordingly, each of the plurality of pixels PX (see FIG. 4) may easily receive the write scan signal SWj through the write scan line SWL during the fourth active period AP4 (see FIG. 6), and the data signal Di may be received through the data line DL during the fourth active period AP4 (see FIG. 6). Accordingly, the electronic device 1000 (see FIG. 1) having an improved display quality may be provided.

The scan driver may include a shift register circuit and a buffer circuit, which is different from the present disclosure. When a load of the shift resistor is large, a buffer circuit may be inserted between the shift register circuit and the load. The load may be determined by the resistance of the write scan line through which the write scan signal is provided. As the intensity of the current for charging or discharging the load used in the buffer circuit is increased, the operating speed may be increased. However, the region of the non-display region NDA (see FIG. 4) may be increased due to the space occupied by the buffer circuit. However, according to the present disclosure, since the first data pattern layer SD1 may include the write scan line SWL, the resistance of the write scan line SWL may be reduced, and the delay of the write scan signal SWj may be reduced. The buffer circuit of the scan driver 300 (see FIG. 4) may be removed, or the number of buffer circuits included in the scan driver 300 (see FIG. 4) may be decreased. Accordingly, the electronic device 1000 (see FIG. 1) having a reduced area of the non-display region NDA (see FIG. 4) may be provided.

In addition, the first gate electrode GE1 may be influenced by a parasitic capacitor, depending on the write scan signal SWj. However, according to the present disclosure, the capacitor electrode CSE may be interposed between the write scan line SWL and the first gate electrode GE1 of the first transistor T1. Accordingly, the parasitic capacitor may not be directly formed between the write scan line SWL and the first gate electrode GE1. Accordingly, the influence of the parasitic capacitor between the first gate electrode GE1 and the write scan signal SWj may be prevented or reduced. Accordingly, it is possible to prevent or remove the influence of the parasitic capacitor on the image quality of the image IM (see FIG. 2) displayed on the display region DA (see FIG. 4). Accordingly, the electronic device 1000 (see FIG. 1) having an improved display quality may be provided.

A plurality of first connecting electrode patterns C_CNE1 may contact at least one of the first semiconductor pattern ACT1 and the second semiconductor pattern ACT2. The plurality of connecting electrode patterns C_CNE1 may electrically connect one of the first semiconductor pattern ACT1 and the second semiconductor pattern ACT2 to a different wire or different lines. The plurality of connecting electrode patterns C_CNE1 may be connected to one of the first semiconductor pattern ACT1 and the second semiconductor pattern ACT2 through a contact hole.

The plurality of first connecting electrode patterns C_CNE1 may include the first connecting electrode CNE10 illustrated in FIG. 8.

For example, one of the plurality of first connecting electrode patterns C_CNE1 may contact the first initializing voltage line VIL and the second semiconductor pattern ACT2. The one of the plurality of first connecting electrode patterns C_CNE1 may electrically connect the first initializing voltage line VIL to the second semiconductor pattern ACT2.

For example, another one among the plurality of first connecting electrode patterns C_CNE1 may make contact with the first semiconductor pattern ACT1 and the second semiconductor pattern ACT2. The another one among the plurality of first connecting electrode patterns C_CNE1 may electrically connect the first semiconductor pattern ACT1 to the second semiconductor pattern ACT2.

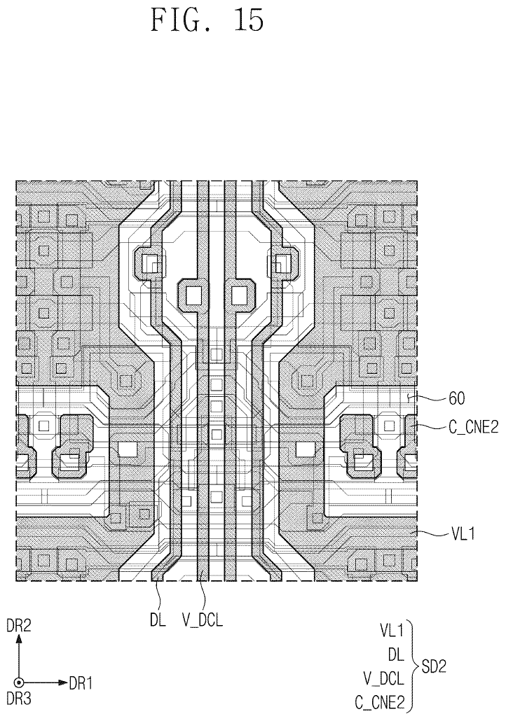

FIG. 15 is a plan view illustrating a portion of a circuit layer according to an embodiment of the preset disclosure.

Referring to FIGS. 5 and 15, the sixth insulating layer 60 may cover the first data pattern layer SD1 (see FIG. 14). The sixth insulating layer 60 may be disposed on the fifth insulating layer 50 (see FIG. 14). The second data pattern layer SD2 may be disposed on the sixth insulating layer 60. The second data pattern layer SD2 may include a metal, an alloy, a conductive metal oxide, or a transparent conductive material.

The second data pattern layer SD2 may include the vertical connecting line V_DCL, the data line DL, the driving voltage line VL1, and a plurality of second connecting electrode patterns C_CNE2.

The vertical connecting line V_DCL may extend in the second direction DR2. The vertical connecting line V_DCL may be connected to a relevant data line DLi and a relevant horizontal connecting line V_DCL (see FIG. 7).

The data line DL may extend in the second direction DR2. The data line DL may be spaced apart from the vertical connecting line V_DCL in the first direction DR1. The data line DL may be connected to the second transistor T2 through a contact hole. The data line DL may correspond to an i-th data line DLi illustrated in FIG. 5. The data signal Di may be provided to the data line DL.

The first driving voltage line VL1 may extend in the second direction DR2. The first driving voltage line VL1 may correspond to the first driving voltage line VL1 illustrated in FIG. 5. The first driving voltage ELVDD may be provided through the first driving voltage line VL1. The first driving voltage line VL1 may be connected to the connecting pattern CP (see FIG. 14) through the contact hole.

The plurality of second connecting electrode patterns C_CNE2 may be connected to the first connecting electrode CNE10. The plurality of second connecting electrode patterns C_CNE2 may be electrically connected to the sixth transistor T6 through a contact hole. The plurality of second connecting electrode patterns C_CNE2 may include the second connecting electrode CNE20 (see FIG. 8).

As described above, as the first data pattern layer may include the write scan line, the resistance of the write scan line may be decreased, and the delay of the write scan signal may be decreased. The scan-on time of the write scan signal may be sufficiently ensured. Accordingly, each of the plurality of pixels may easily receive the write scan signal through the write scan line during the scan-on time, and the data signal may be received through the data line during the scan-on time. Accordingly, the electronic device having an improved display quality may be provided.

In addition, as described above, as the first data pattern layer may include the write scan line, the resistance of the write scan line may be decreased, and the delay of the write scan signal may be decreased. Accordingly, in the scan driver, the buffer circuit may be removed, or the number of the buffer circuits may be reduced. Accordingly, the electronic device having a reduced area of the non-display region may be provided.

Although an embodiment of the present disclosure has been described for illustrative purposes, those skilled in the art will appreciate that various modifications and changes can be made to the inventive concept without departing from the scope and spirit of the present disclosure as set forth and defined in the following claims.

Accordingly, it is understood that the technical scope of the present disclosure should not be limited to the content described in the detailed description of the specification, but should be determined by the claims described hereinafter.

What is claimed is:

1. An electronic device comprising:
a light emitting element;
a data line configured to provide a data signal;
a pixel circuit connected to the light emitting element; and
a plurality of scan lines connected to the pixel circuit,
wherein the plurality of scan lines include:
an initializing scan line extending in a first direction and providing an initializing scan signal; and
a write scan line extending in the first direction and providing a write scan signal,
wherein the pixel circuit includes:
a first transistor including a first semiconductor pattern which includes a first electrode and a second electrode and includes a first material, and a first gate electrode;
a second transistor including a second gate electrode which receives the write scan signal, and connected between the first electrode and the data line; and
a third transistor including a second semiconductor pattern including a second material different from the first material, receiving the initializing scan signal and connected to the first gate electrode, and
wherein the initializing scan line, the write scan line, and the first gate electrode are disposed on different layers from each other.

2. The electronic device of claim 1, wherein the write scan line is overlapped with at least a portion of the first gate electrode, when viewed in a plan view.

3. The electronic device of claim 1, further comprising:
a first initializing voltage line disposed on a same layer the first gate electrode, extending in the first direction, and providing a first initializing voltage.

4. The electronic device of claim 3, wherein the first initializing voltage line is electrically connected to the second semiconductor pattern.

5. The electronic device of claim 3, wherein the first initializing voltage line is disposed on a different layer from the write scan line.

6. The electronic device of claim 1, wherein the plurality of scan lines further include:
a compensating scan line extending in the first direction and providing a compensating scan signal, and
wherein the pixel circuit further includes:
a fourth transistor including a fourth gate electrode which receives the compensating scan signal, the second semiconductor pattern, and electrically connected between the second electrode and the first gate electrode.

7. The electronic device of claim 6, wherein the compensating scan line is disposed on a same layer as the initializing scan line, and the compensating scan line and the initializing scan line are spaced apart from each other in a second direction crossing the first direction.

8. The electronic device of claim 6, wherein the compensating scan line is disposed on a different layer from the write scan line.

9. The electronic device of claim 1, wherein the plurality of scan lines further include:
a light emitting control line extending in the first direction and providing a light emitting control signal, and
wherein the pixel circuit further includes:
a fifth transistor connected to the first electrode receiving the light emitting control signal.

10. The electronic device of claim 9, wherein the light emitting control line is disposed on a different layer from the write scan line.

11. The electronic device of claim 1, wherein the pixel circuit further includes:
a connecting pattern disposed on a same layer as the write scan line; and
a capacitor electrode overlapped with the first gate electrode, when viewed in a plan view.

12. The electronic device of claim 11, further comprising:
a first driving voltage line extending in a second direction crossing the first direction and providing a first driving voltage,
wherein the connecting pattern is connected to the first driving voltage line through a contact hole.

13. The electronic device of claim 12, wherein the first driving voltage line is disposed on a same layer as the data line.

14. The electronic device of claim 12, wherein the connecting pattern is overlapped with the capacitor electrode, when viewed in the plan view.

15. The electronic device of claim 11, wherein the write scan line is spaced apart from the connecting pattern in a second direction crossing the first direction, when viewed in the plan view.

16. The electronic device of claim 11, wherein the write scan line is overlapped with at least a portion of the capacitor electrode, when viewed in the plan view.

17. The electronic device of claim 1, wherein the second gate electrode is disposed on a same layer as the first gate electrode, and
wherein the second gate electrode is connected to the write scan line through a contact hole.

18. An electrode device comprising:
a pixel circuit;
a data line configured to provide a data signal; and
a plurality of scan lines connected to the pixel circuit,
wherein the plurality of scan lines include:
an initializing scan line extending in a first direction and providing an initializing scan signal; and
a write scan line extending in the first direction and providing a write scan signal,
wherein the pixel circuit includes:
a first transistor including a first gate electrode;
a second transistor including a second gate electrode which receives the write scan signal, and connected between the first transistor and the data line;
a third transistor including a third gate electrode which receives the initializing scan signal, and connected to the first gate electrode; and
a capacitor electrode overlapped with the first gate electrode, when viewed in a plan view, and
wherein the write scan line is disposed between the initializing scan line and the data line.

19. The electronic device of claim 18, wherein the write scan line is overlapped with at least a portion of the first gate electrode, when viewed in the plan view, and
wherein the write scan line is overlapped with at least a portion of the capacitor electrode, when viewed in the plan view.

20. The electronic device of claim 18, wherein the second gate electrode is disposed on a same layer as the first gate electrode, and
wherein the second gate electrode is connected to the write scan line through a contact hole.
